(19) United States
(12) Patent Application Publication
(10) Pub. No.: US 2022/0164703 A1
(43) Pub. Date: May 26, 2022

(54) MODEL ACCEPTANCE DETERMINATION SUPPORT SYSTEM AND MODEL ACCEPTANCE DETERMINATION SUPPORT METHOD

(71) Applicant: Hitachi, Ltd., Tokyo (JP)

(72) Inventors: Shin TEZUKA, Tokyo (JP); Satoru MORIYA, Tokyo (JP); Keisuke HATASAKI, Tokyo (JP); Yoshiko YASUDA, Tokyo (JP); Junji KINOSHITA, Tokyo (JP)

(21) Appl. No.: 17/438,370

(22) PCT Filed: Mar. 6, 2020
(86) PCT No.: PCT/JP2020/009875

§ 371 Date: Sep. 10, 2021

(30) Foreign Application Priority Data
Mar. 29, 2019 (JP) 2019-067721

(51) Int. Cl. G06N 20/00

(52) U.S. Cl. CPC G06N 20/00

(57) ABSTRACT

In the information registered by a system, a learning model is associated with a dataset which is one or more dataset elements serving as an input of the learning model, and a dataset is associated with a filter of the dataset. The system evaluates the learning model using a processed dataset which is a dataset obtained on the basis of a dataset associated with an evaluation target learning model and a filter associated with the dataset. The system displays at least a part of information associated with a browsing target learning model and information indicating a result of evaluation of the learning model.

### TECHNICAL FIELD

The present invention generally relates to a novel technique for supporting determination of acceptance of a learning model which is a model developed using machine learning.

### BACKGROUND ART

Services and applications that use a learning model which is a model developed using machine learning have emerged. However, it is difficult to develop a complete learning model (hereinafter, a model) without erroneous determination or the like. Therefore, a model developer who develops a model frequently improves the model, for example, in order to improve the quality of the model. When such model improvement is performed, the model developer focuses on the most important index, and tries to improve the model so that this index has a better value.

On the other hand, there may be no model that completely matches the requirements of the application. For example, a case is considered in which an application developer requests a model that captures a sign of failure of a certain motor and obtains a probability of occurrence of bearing breakage in the near future from a change in the input rotation speed of a motor and vibration data of a bearing. When there is no model that meets the requirements, the application developer searches for a model having a similar purpose, for example, using a model that obtains failure probabilities of both bearing breakage and coil breakage. However, there is a case where a model developer who has developed the model improves the model by considering maximization of an average value or the like of prediction accuracy of two failures as an important index.

In such a case, since the indices that the model developer and the application developer focus on are different, the results expected by the application developer are obtained in a certain version of the model. However, the results expected by the application developer are not necessarily obtained in a new model improved by focusing only on the indices that the model developer focuses on and the requirements of the application may not be satisfied. That is, the application developer needs to conduct a test (an example of evaluation) on the model each time in order to determine whether the model that is improved every moment satisfies the requirements. However, execution of the test incurs a heavy technical, financial, and time load on application developers, such as collection of necessary datasets and development of a test program.

For example, PTL 1 discloses a device that selects a test for a program.

### CITATION LIST

### Patent Literature

PTL 1: WO2017/199517

### SUMMARY OF INVENTION

### Technical Problem

Considering a program related to an application as a model, it may be possible to execute a necessary test in response to update of the model according to PTL 1. However, even if the test can be selectively executed, an application developer cannot always prepare data of a sufficient amount and quality required for the test. In addition, it is conceivable that an application developer uses the test data used by the model developer for evaluation of the model, but the dataset is generally valuable information for the model developer, and it may be difficult to disclose the dataset to a model user such as an application developer.

Therefore, one object of the present application is to reduce the load on a model user regarding the model acceptance determination even if it is difficult to disclose the dataset of a model developer to the model user.

### Solution to Problem

The system registers model information on each of one or more learning models, dataset information on each of one or more datasets, and filter information on each of one or more filters. Each of the one or more learning models is associated with a dataset which is one or more dataset elements serving as an input of the learning model among the one or more datasets. Each of the one or more datasets is associated with a filter of the dataset among the one or more filters. The system evaluates each of the one or more learning models using a dataset associated with the learning model and a processed dataset which is a dataset obtained on the basis of a filter associated with the dataset when the learning model is an evaluation target learning model. The system displays at least a part of information associated with each of the one or more learning models and information indicating a result of evaluation of the learning model when the learning model is a browsing target learning model.

### Advantageous Effects of Invention

According to the present invention, it is expected that the load on a model user regarding the model acceptance determination is reduced even if it is difficult to disclose the dataset of a model developer to the model user.

### BRIEF DESCRIPTION OF DRAWINGS

FIG. 1 is a diagram illustrating an example of an overview of a model acceptance determination support system.

FIG. 2A is a diagram illustrating a part of a configuration example of the entire system according to a first embodiment.

FIG. 2B is a diagram illustrating the rest of the configuration example of the entire system according to the first embodiment.

FIG. 3 is a diagram illustrating a configuration example of a computer.

FIG. 4 is a diagram illustrating a configuration example of a model management table.

FIG. 5 is a diagram illustrating a configuration example of a dataset management table.

FIG. 6 is a diagram illustrating a configuration example of an evaluation program management table.

FIG. 7 is a diagram illustrating a configuration example of a filter management table.

FIG. 8 is a diagram illustrating a configuration example of an evaluation setting management table.

FIG. 9 is a diagram illustrating a configuration example of an evaluation job management table.

FIG. 10 is a diagram illustrating a configuration example of an evaluation result management table.

FIG. 11 is a diagram illustrating a configuration example of a computer management table.

FIG. 12 is a diagram illustrating a configuration example of a user management table.

FIG. 13 is a diagram illustrating a configuration example of a tenant management table.

FIG. 14 is a flowchart of an IF program.

FIG. 15 is a flowchart of a model management program.

FIG. 16 is a flowchart of an evaluation control program.

FIG. 17 is a flowchart of an evaluation execution program.

FIG. 18 is a view illustrating an example of a model list screen.

FIG. 19A is a view illustrating the entire example of a model detail screen.

FIG. 19B is a view illustrating a part of an example of the model detail screen.

FIG. 19C is a view illustrating a part of an example of the model detail screen.

FIG. 20A is a diagram illustrating an entire example of a model evaluation setting screen.

FIG. 20B is a diagram illustrating a part of an example of a model evaluation setting screen.

FIG. 20C is a diagram illustrating a part of an example of a model evaluation setting screen.

FIG. 21A is a view illustrating the entire example of a model registration screen.

FIG. 21B is a view illustrating a part of an example of a model registration screen.

FIG. 21C is a view illustrating a part of an example of the model registration screen.

FIG. 22 is a diagram illustrating a configuration example of an operation management table.

FIG. 23 is a flowchart of a model operation program.

### DESCRIPTION OF EMBODIMENTS

In the following description, an “interface device” includes one or more interface devices. The one or more interface devices may be at least one of the following.
One or more input/output (I/O) interface devices. An input/output (I/O) interface device is an interface device for at least one of an I/O device and a remote display computer. The I/O interface device for the display computer may be a communication interface device. At least one I/O device may be either a user interface device, an input device such as, for example, a keyboard and a pointing device, or an output device such as a display device.
One or more communication interface devices. One or more communication interface devices may be one or more communication interface devices of the same type (for example, one or more network interface cards (NICs)) and may be two or more communication interface devices of different types (for example, a NIC and a host bus adapter (HBA)).

In the following description, a “memory” is one or more memory devices, and may typically be a main storage device. At least one memory device in the memory may be a volatile memory device or a non-volatile memory device.

In the following description, a “persistent storage device” is one or more persistent storage devices. The persistent storage device is typically a non-volatile storage device (for example, an auxiliary storage device), and is specifically, for example, a hard disk drive (HDD) or a solid state drive (SSD).

In the following description, a “storage device” may be a memory and at least the memory of a permanent storage device.

In the following description, a “processor” is one or more processor devices. At least one processor device is typically a microprocessor device such as a central processing unit (CPU), but may be another type of processor device such as a graphics processing unit (GPU). At least one processor device may be a single-core or a multi-core. At least one processor device may be a processor core. At least one processor device may be a processor device in a broad sense, such as a hardware circuit (for example, a field-programmable gate array (FPGA) or an application specific integrated circuit (ASIC)) that performs a part or all of the processing steps.

In the following description, information from which an output is obtained for an input may be described using an expression of an “xxx table”, but the information may be data having any structure. Therefore, the “xxx table” can be referred to as “xxx information”. In the following description, the configuration of each table is an example, one table may be divided into two or more tables, and all or a part of two or more tables may be integrated into one table.

In the following description, a function may be described using an expression of a “kkk unit”, but the function may be realized by a processor executing one or more computer programs, or may be realized by one or more hardware circuits (for example, FPGA or ASIC). When the function is realized by a processor executing the program, defined processing is appropriately performed using a storage device and/or an interface device, and thus, the function may be at least a part of the processor. The processing described using the function as a subject may be processing performed by a processor or a device including the processor. The program may be installed from a program source. The program source may be, for example, a program distribution computer or a computer-readable recording medium (for example, a non-transitory recording medium). The description of each function is an example, and a plurality of functions may be integrated into one function or one function may be divided into a plurality of functions.

Furthermore, in the following description, there is a case where processing is described using a “program” as a subject, but since the program is executed by a processor to perform defined processing appropriately using a storage device and/or an interface device, the subject of the processing may be a processor (alternatively, a device such as a controller having the processor). The program may be installed in a device such as a computer from a program source. The program source may be, for example, a program distribution server or a computer-readable (for example, non-transitory) recording medium. In the following description, two or more programs may be realized as one program, or one program may be realized as two or more programs.

Furthermore, in the following description, a “model acceptance determination support system” may be configured by one or more computers, or may be realized on a resource pool (for example, a cloud infrastructure) including a plurality of computation resources. For example, when a computer has a display device and the computer displays information on its own display device, the computer may be a model acceptance determination support system. “Displaying information” may mean displaying the information on a display device included in the model acceptance determination support system, or may mean the model acceptance determination support system transmitting the information to a remote display computer (in the latter case, the information is displayed by the display computer).

Hereinafter, some embodiments, which are embodiments for carrying out the present invention, will be described with reference to the drawings, and finally, these embodiments will be summarized. The following embodiments and drawings illustrated below are examples of embodiments for carrying out the present invention, and are not intended to limit application to other configurations and embodiments capable of similar processing.

### Embodiment 1

In the first embodiment, when an application developer develops an application for diagnosing a failure sign of bearing breakage of a certain motor, a case where acceptance of a model that is improved every moment is determined is taken as an example.

An application calls a model developed by a model developer using an application programming interface (API) or the like, and performs diagnosis. However, there is no model that can diagnose the sign of only bearing breakage with high accuracy, and the application developer uses, from the application, a model that can diagnose failures other than bearing breakage such as coil breakage although the accuracy is poor. On the other hand, a model developer who has developed the model improves the model considering maximization of an average value of prediction accuracy the diagnosis of a plurality of types of failure signs as an important index.

In such a case, since the indices that the model developer and the application developer focus on are different, the results expected by the application developer can be obtained in a certain version of model, but the results expected by the application developer are not necessarily obtained in a new model with improved index that the model developer focuses on. Therefore, the application developer conducts a test or the like on the model that is improved every moment.

In the first embodiment, the model acceptance determination support system receives designation of a dataset requested by an application developer, a dataset filter, and an index used for determining acceptance of a model improved for a marketplace system from the application developer, and evaluates the improved model according to the designation. The application developer makes an acceptance determination on the basis of a result of the evaluation. That is, the model acceptance determination support system according to the first embodiment enables the application developer to obtain a desired evaluation result in a state where the content of the dataset provided by the model developer is not disclosed to the application developer.

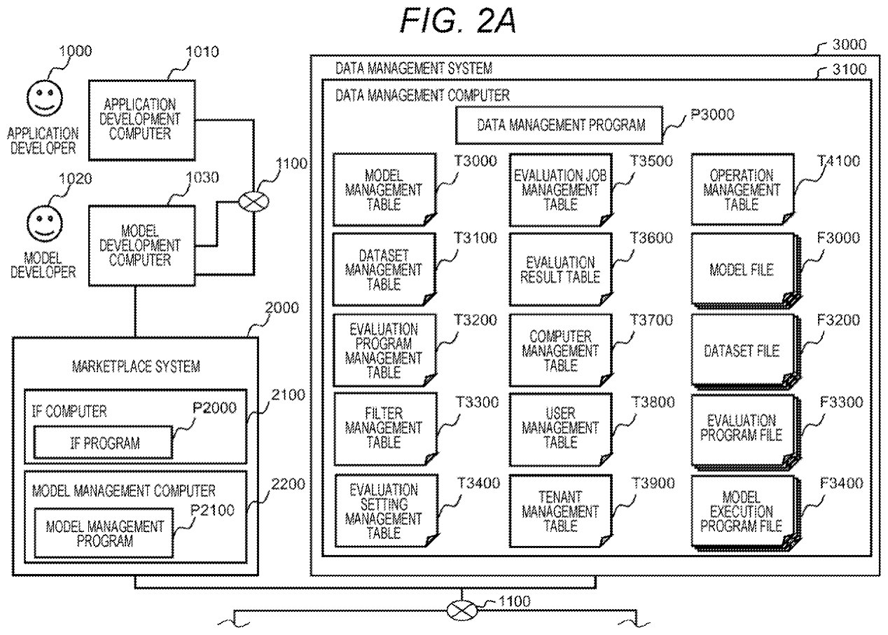

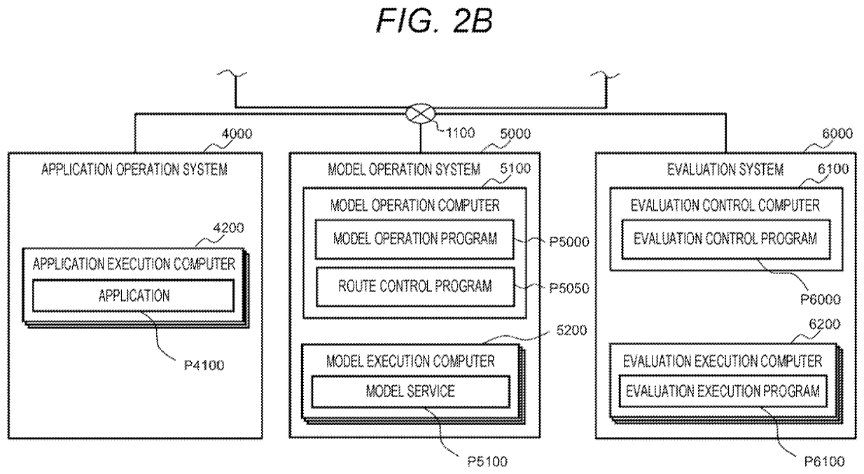

FIGS. 2A and 2B are diagrams illustrating a configuration example of the entire system according to the first embodiment. In the following description, regarding various components of the system, the number of the components is “one or more”, but the components are treated as singular appropriately for the sake of simplicity of description. Each computer described below includes an interface device, a storage device, and a processor connected to them. Each computer communicates via the interface device. In each computer, a storage device stores a program and information (for example, a table and a file). In each computer, a processor executes a program.

The model acceptance support system includes one or more marketplace systems 2000, one or more data management systems 3000, one or more application operation systems 4000, one or more model operation systems 5000, and one or more evaluation systems 6000.

The marketplace system 2000 is responsible for model management and receives requests from an application developer 1000 and a model developer 1020. The data management system 3000 manages data necessary for model management. The application operation system 4000 operates an application developed by the application developer 1000. The model operation system 5000 operates a model developed by the model developer 1020. The evaluation system 6000 evaluates the model.

One or more application developers 1000 develop an application using one or more application development computers 1010, and search for a model used by the application, collect detailed information on the model, and evaluate the model. The application development computer 1010 communicates with the marketplace system 2000 via one or more networks 1100.

One or more model developers 1020 develop a model using one or more model development computers 1030, register the model in the marketplace system 2000, and evaluate the model. The model development computer 1030 communicates with the marketplace system 2000 via one or more networks 1100.

The application developer 1000 and the model developer 1020 may be a human or a program as long as they can request the marketplace system 2000 to register and evaluate the model.

The marketplace system 2000 includes one or more interface (IF) computers 2100 and one or more model management computers 2200.

The IF computer 2100 executes a model IF program P2000. The model IF program P2000 receives a request from the application developer 1000 or the model developer 1020 via the application development computer 1010 or the model development computer 1030, and executes processing in accordance with the request.

The model management computer 2200 executes a model management program P2100. The model management program P2100 manages models according to the request received from the IF program P2000.

The data management system 3000 includes one or more data management computers 3100.

The data management computer 3100 includes a data management program P3000 for managing data (and inputting and outputting data to and from another computer), a model management table T3000 including model information, a dataset management table T3100 including information having a dataset serving as an input at the time of evaluating a model, an evaluation program management table T3200 including information on an evaluation program for evaluating a model using a model and a dataset as inputs, a filter management table T3300 including information on a filter in which a processing method or the like of a dataset used for model evaluation is designated, an evaluation setting management table T3400 including information related to evaluation setting, an evaluation job management table T3500 including information on an execution state of model evaluation processing, an evaluation result management table T3600 including result information of model evaluation, a computer management table T3700 including information on a computer that executes model evaluation processing, a user management table T3800 including information on the application developer 1000 and the model developer 1020, a tenant management table T3900 including information on a tenant which is a set of a plurality of users, an operation management table T4100 including information on a model available from an application, a model file F3000 that is an entity of a model, a dataset file F3200 that is an entity of a dataset; an evaluation program file F3300 that is an entity of the evaluation program, and a model execution program file F3400 used for operation of a deployed model.

The contents of all data and files included in the data management system 3000 are transmitted and received via the data management program P3000 included in the data management computer 3100. An example of the data management program P3000 is a database management system (DBMS), but the data management program P3000 may be a program other than the DBMS as long as it can manage data and files. In addition, for data and file persistence, a database such as a relational database or NoSQL may be used, a file system may be used, or a system other than the database and the file system may be used.

The operation management table T4100 and the model execution program file F3400 will be described later.

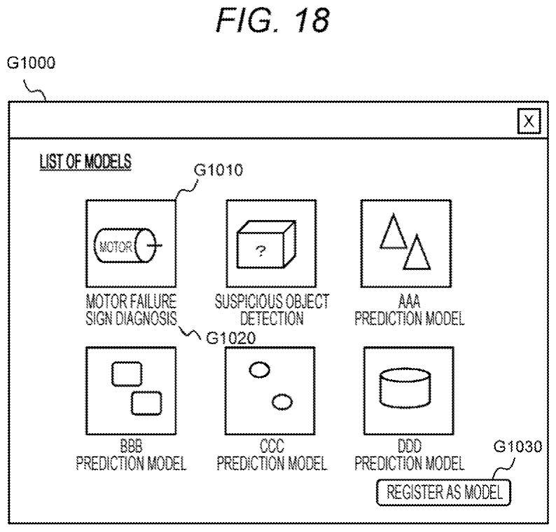

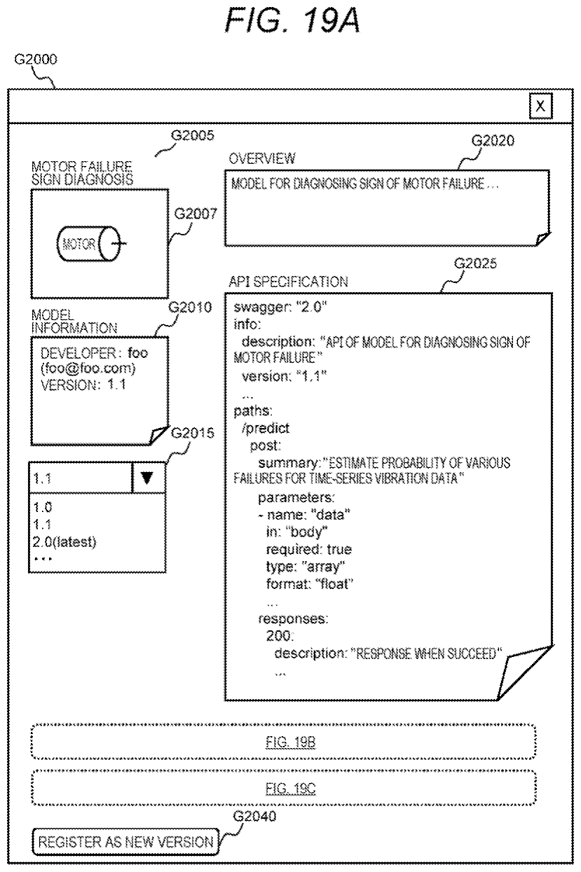

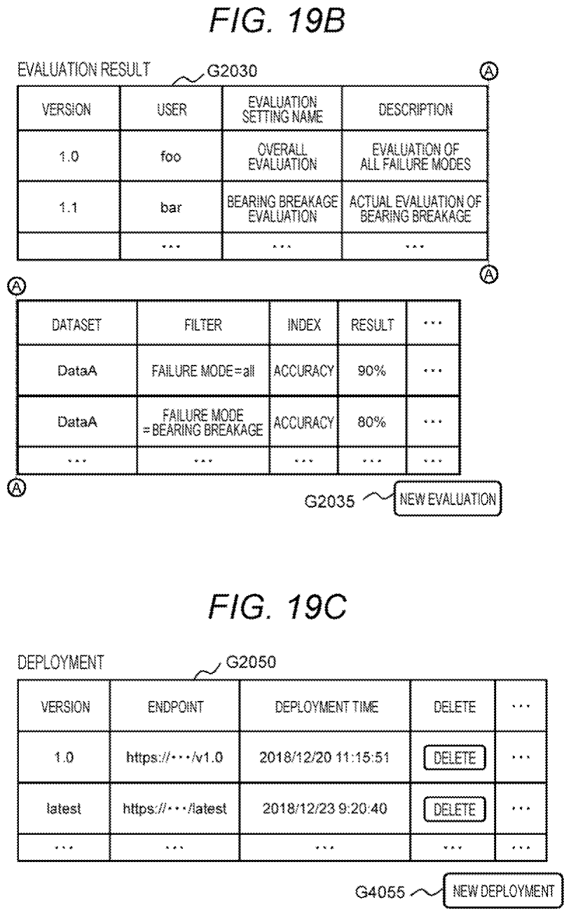

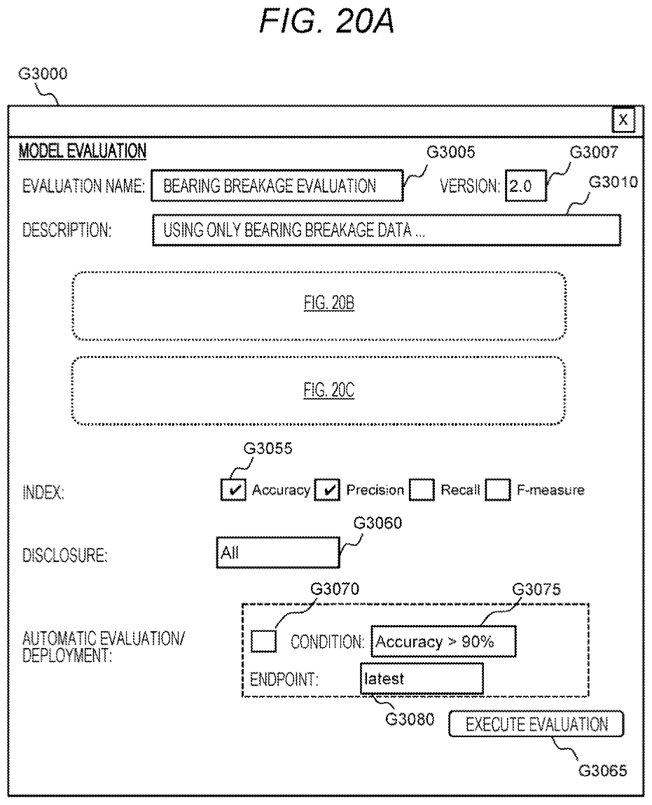

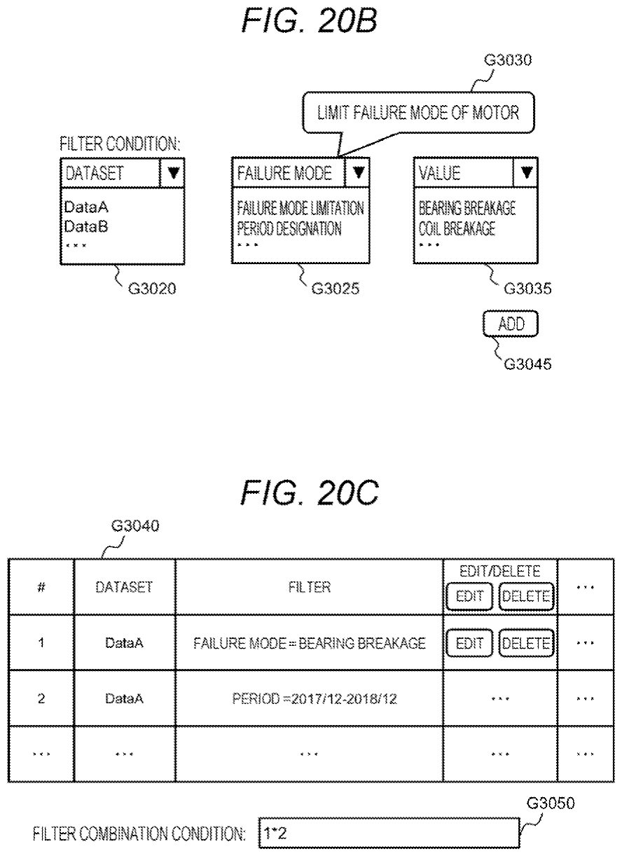

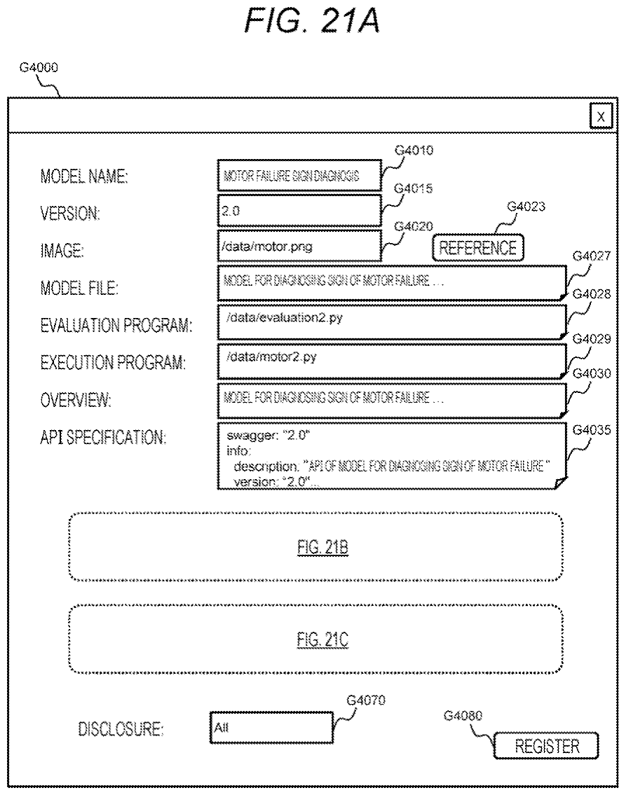

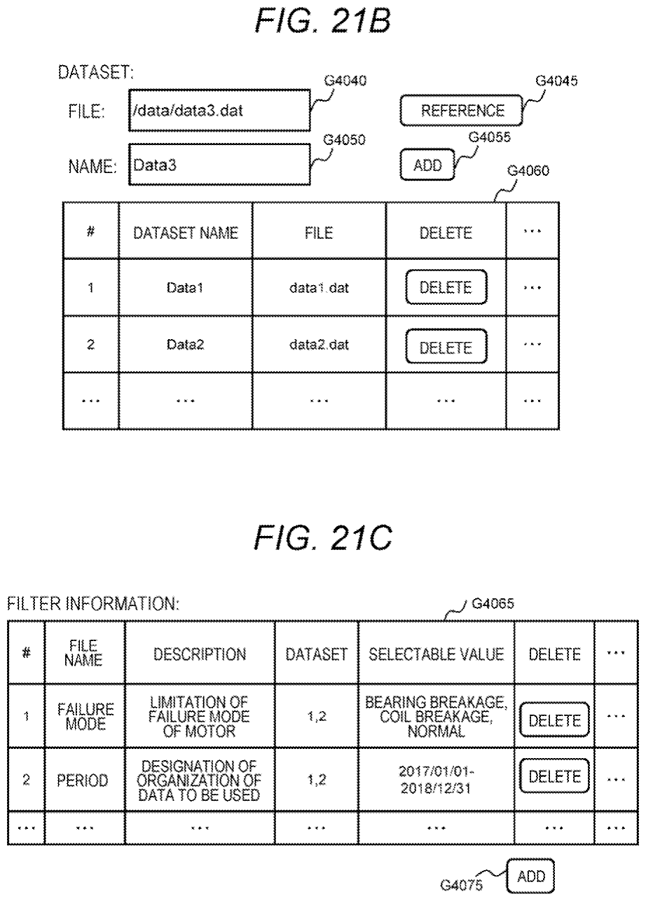

The IF program P2000 may provide a model list screen G1000 (see FIG. 18), a model detail screen G2000 (see FIGS. 19A to 19C), a model evaluation setting screen G3000 (see FIGS. 20A to 20C), and a model registration screen G4000 (see FIGS. 21A to 21C) via, for example, a browser or the like included in the application development computer 1010 or the model development computer 1030.

The application operation system 4000 includes one or more application execution computers 4200. The application execution computer 4200 includes one or more developed applications P4100. The application P4100 is deployed to the application operation system 4000 by the application developer 1000 to access an endpoint provided by the model operation system 5000 via the network 1100 using the API, and use the function of the model such as inference provided by a model service P5100. The application execution computer 4200 may record a log including operation information of each application or transmit the log to another computer.

The model operation system 5000 includes one or more model operation computers 5100 and one or more model execution computers 5200. The model operation computer 5100 includes a model operation program P5000 that manages the model being executed and a route control program P5050 that controls access to the model via the API. The model execution computer 5200 includes a model service P5100 that provides the functions of one or more developed models. The model operation computer 5100 and the model execution computer P5100 may record a log including the operation information of each model or transmit the log to another computer.

The model operation system will be described later.

The evaluation system 6000 includes one or more evaluation control computers 6100 and one or more evaluation execution computers 6200. The evaluation control computer 6100 includes an evaluation control program P6000 that controls model evaluation processing. The evaluation execution computer 6200 includes an evaluation execution program P6100 that executes evaluation processing. The evaluation control computer 6100 and the evaluation execution computer 6200 may record a log including information such as the progress of each evaluation processing or transmit the log to another computer.

The computers illustrated in FIGS. 2A and 2B are connected by one or more networks 1100. An example of the network 1100 is the Internet, and may be a virtual private network (VPN) or other networks.

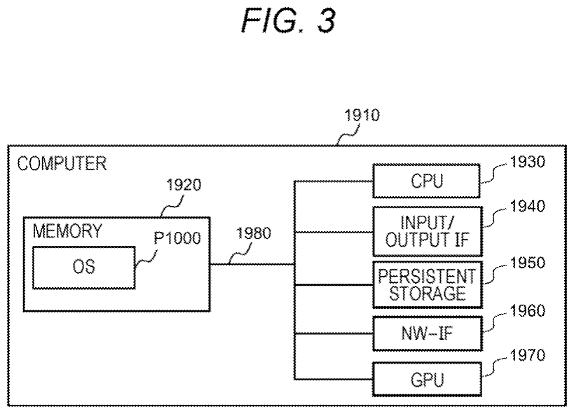

FIG. 3 is a diagram illustrating a configuration example of elements common to each computer.

The computer 1910 includes a memory 1920, a CPU 1930, an input/output IF 1940, a persistent storage device 1950, an NW-IF 1960, and a GPU 1970, which are connected by an internal bus 1980.

The program is stored in the persistent storage device 1950, loaded into the memory 1920, and executed by the CPU 1930. An operating system (OS) is loaded into the memories of all the computers 1910 included in the system of the present application and is executed by the CPU 1930.

All the computers may be physical computers or virtual computers operating on the physical computers. In addition, the storage device of each computer is not an essential element, and may be, for example, an external storage device or a storage service that logically provides the function of the storage device.

An example of the NW-IF provided in each computer is a network interface card (NIC), but other interfaces may be used.

An output device such as a display or an input/output IF such as a keyboard and a mouse may be provided, and when the computer is remotely managed via a network by means such as Secure Shell (SSH), the input IF is not an essential element. The GPU 1970 is not an essential element.

The program and the table included in each computer described above may be included in a storage device included in each computer. In addition, all the programs are executed by the CPU included in each computer.

Each program may be executed by a plurality of different computers as described above, or may be executed by one computer. In addition, all the steps of each program may be executed by one computer, or may be executed by different computers for respective steps.

Components other than the components exemplified in FIG. 3, wiring connecting the components, and the like may be included in the computer.

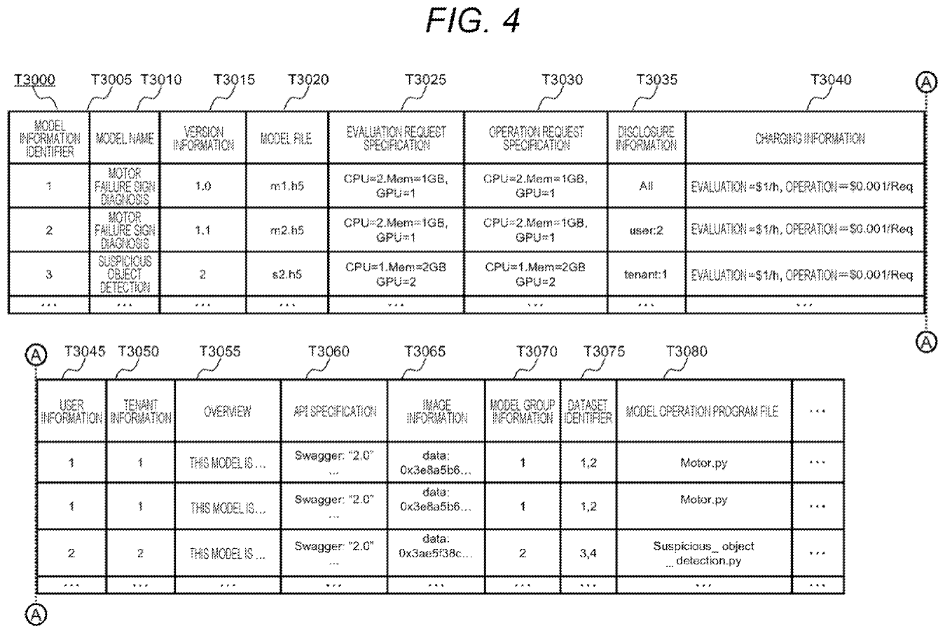

FIG. 4 is a diagram illustrating a configuration example of the model management table T3000.

Each record in the model management table T3000 stores model information necessary for management of each model registered in the marketplace system 2000. Each record records model information of each version of the model. Not only the same type of models having the same purpose are described in the model management table T3000, but information on different types of models such as suspicious object detection in addition to the diagnosis of signs of motor failures may be described as in the configuration example of the drawing.

In the model management table T3000, a record is stored for each model. Hereinafter, one model will be taken as an example (“target model” in the description of FIG. 4).

The model information stored in the record corresponding to the target model includes, for example, a model information identifier T3005, a model name T3010, version information T3015, a model file T3020, an evaluation request specification T3025, an operation request specification T3030, disclosure information T3050, charging information T3040, user information T3045, tenant information T3050, an overview T3055, an API specification T3060, image information T3065, model group information T3070, a dataset identifier T3075, and a model operation program file T3080.

The model information identifier T3005 indicates an identifier for uniquely identifying the model information of the target model. The identifier may be a value (for example, a serial number) assigned by the data management program P3000.

The model name T3010 indicates the name of the target model. The name may be, for example, a character string input by the model developer 1020 via the model registration screen G4000, and may be displayed on the model list screen G1000 or the model detail screen G2000.

The version information T3015 indicates a value for identifying the version of the target model. The same model may be determined, for example, from the fact that the values of the model group information T3070 are the same. The value of the version information T3015 may be expressed by, for example, a numerical value, and may be other values as long as the version of the model can be uniquely identified.

The model file T3020 indicates the file name of a file (for example, a file including network information and weight information of deep learning) as an entity of the target model. The file name may be, for example, a file name designated via the model registration screen G4000 or a file name uniquely assigned by the data management program P3000 that has received the model file.

The evaluation request specification T3025 indicates the performance of the CPU 1930 and the memory 1920 required for the evaluation execution computer 6200 when evaluating the target model. The performance may be used, for example, for the evaluation control program P6000 to select which evaluation execution computer P6200 executes the evaluation.

The operation request specification T3030 indicates the performance of the CPU 1930 and the memory 1920 required for the model execution computer 5200 when the target model is operated by the model execution computer 5200 of the model operation system 5000. The performance may be used, for example, for the model operation program P5000 to select which model execution computer 5200 executes the model.

The disclosure information T3050 indicates a value for controlling a range (a user, a tenant, or the like) in which the model information of the target model is disclosed. For example, a user to which the target model is to be disclosed may be controlled in such a way that the target model is disclosed to all users if the value is “All” in the model list screen G1000, and the target model is disclosed to only a user who has accessed the screen and whose identifier is “1” and is not disclosed to other users when the value is “user:1”. In order to designate a non-disclosure user in addition to a disclosure user, a value such as “not” expressing negation such as “not user:1” may be included.

The charging information T3040 includes a value used when evaluating or operating the target model. The value may be an amount or the like charged to the user who has requested evaluation or operation. For example, when “$0.001” per evaluation is requested for the user who has requested the evaluation, the value may be expressed as “$0.001/Req” or the like.

The user information T3045 indicates the identifier of a user who has registered each version of the target model in the marketplace system 2000 via the model registration screen G4000 or the like. As the identifier, for example, the value of the user identifier T3810 included in the user management table T3800 may be used.

The tenant information T3050 indicates the identifier of a tenant to which the user who has registered each version of the target model in the marketplace system 2000 via the model registration screen G4000 or the like belongs. The identifier may be, for example, the value of the tenant identifier T3810 included in the tenant management table T3900.

The overview T3055 indicates, for example, information used when a description of the target model is displayed on the model detail screen G2000 or the like. The information may be information (for example, information in a text format or a Markdown format) input by the model developer 1020 on the model registration screen G4000.

The API specification T3060 may be information indicating the API specification when the target model is used from the application P4100. For example, the information may be displayed on the model detail screen G2000 or the like, or may be input from the model developer 1020 via the model registration screen G4000. The information may be, for example, information in any of a text format, a Markdown format, a HyperText Markup Language (HTML) format, a JavaScript (registered trademark) Object Notation (JSON) format, and a YAML Ain′t a Markup Language (YAML) format.

The image information T3065 is, for example, information indicating an image of the target model displayed on the model detail screen G2000 or the like. The information may be, for example, information designated by the model developer 1020 on the model registration screen G4000.

The model group information T3070 indicates an identifier for identifying that the target model belongs to the same group as a model that has a different version from the target model. The identifier may be, for example, the value of the model identifier T3005 of the record including the model information of the initially registered version.

The dataset identifier T3075 may be an identifier that identifies a dataset used in the evaluation of the target model performed by the evaluation system 6000. The identifier may be, for example, the value of the dataset identifier T3110 included in the dataset management table T3100 that manages the dataset designated on the model registration screen G4000.

The model operation program file T3080 will be described later.

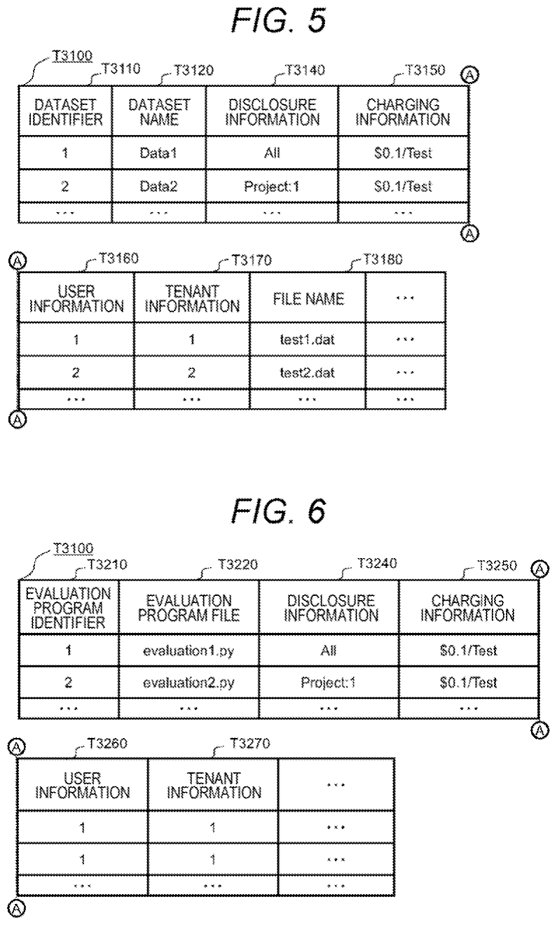

FIG. 5 is a diagram illustrating a configuration example of the dataset management table T3100.

Each record in the dataset management table T3100 stores dataset information for managing datasets necessary for evaluation of each model registered in the marketplace system 2000.

In the dataset management table T3100, a record is stored for each dataset. Hereinafter, one dataset is taken as an example (“target dataset” in the description of FIG. 5).

The dataset information stored in the record corresponding to the target dataset includes, for example, a dataset identifier T3110, a dataset name T3120, disclosure information T3140, charging information T3150, user information T3160, tenant information T3170, and a file name T3180.

The dataset information identifier T110 indicates an identifier for uniquely identifying the dataset information of the target dataset. The identifier may be a value (for example, a serial number) assigned by the data management program P3000.

The dataset name T3120 indicates the name of the target dataset. The name may be, for example, the name designated by the model developer 1020 on the model registration screen G4000.

The disclosure information T3140 indicates a value for controlling a range (a user, a tenant, or the like) in which the dataset information of the target dataset is disclosed. The value may be the same as the value of the disclosure information T3050.

The charging information T3150 includes a value expressing an amount or the like charged for each user when evaluating the model using the target dataset. For example, when “$0.001” per test is requested to the user who has requested the evaluation, the value may be expressed as “$0.001/Test” or the like.

The user information T3160 indicates the identifier of a user who has registered the target dataset via the model registration screen G4000 or the like. The identifier may be, for example, the value of the user identifier T3810 included in the user management table T3800.

The tenant information T3170 indicates the identifier of a tenant to which the user who has registered the target dataset via the model registration screen G4000 or the like belongs. The value may be, for example, the value of the tenant identifier T3910 included in the tenant management table T3900.

The file name T3180 indicates the file name of the file of the target dataset registered via the model registration screen G4000 or the like. The file name may be, for example, a file name designated by the user on the model registration screen G4000 or a value automatically assigned by the data management program P3000.

FIG. 6 is a diagram illustrating a configuration example of the evaluation program management table T3200.

Each record in the evaluation program management table T3200 stores evaluation program information for managing an evaluation program necessary for evaluation of each model registered in the marketplace system 2000.

In the evaluation program table T3200, a record is stored for each evaluation program. Hereinafter, one evaluation program will be taken as an example (“target evaluation program” in the description of FIG. 6).

The evaluation program information stored in the record corresponding to the target evaluation program includes, for example, an evaluation program identifier T3210, an evaluation program file T3220, disclosure information T3240, charging information T3250, user information T3260, and tenant information T3270.

The evaluation program identifier T3210 indicates an identifier for uniquely identifying the evaluation program information of the target evaluation program. The identifier may be a value (for example, a serial number) assigned by the data management program P3000.

The evaluation program file T3220 indicates a file name of the file of the target evaluation program. The file name may be, for example, a file name designated by the user via the model registration screen G4000 or a value automatically assigned by the data management program P3000.

The disclosure information T3240 indicates a value for controlling the range in which the evaluation program information of the target evaluation program is disclosed. The value may be the same as the value of the disclosure information T3050.

The charging information T3250 includes a value expressing an amount or the like charged for each user when evaluating the model using the target evaluation program. For example, when “$0.001” per test is requested to the user who has requested the evaluation, the value may be expressed as “$0.001/Test” or the like.

The user information T3260 indicates the identifier of a user who has registered the target evaluation program via the model registration screen G4000 or the like. The identifier may be, for example, the value of the user identifier T3810 included in the user management table T3800.

The tenant information T3270 indicates the identifier of a tenant to which the user who has registered the target evaluation program via the model registration screen G4000 or the like belongs. The identifier may be, for example, the value of the tenant identifier T3910 included in the tenant management table T3900.

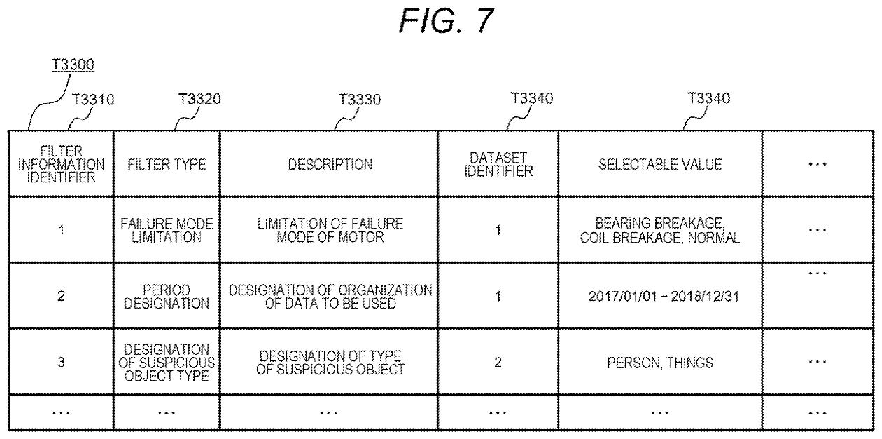

FIG. 7 is a diagram illustrating a configuration example of the filter management table T3300.

Each record in the filter management table T3300 stores filter information (information indicating which data processing can be performed on which dataset when evaluating each model registered in the marketplace system 2000).

In the filter management table T3300, a record is stored for each filter. Hereinafter, one filter will be taken as an example (“target filter” in the description of FIG. 7).

The filter information stored in the record corresponding to the target filter includes, for example, a filter information identifier T3310, a filter name T3220, a description T3330, a dataset identifier T3340, and a selectable value T3340.

The filter information identifier T3310 indicates an identifier for uniquely identifying the filter information of the target filter. The identifier may be a value (for example, a serial number) assigned by the data management program P3000.

The filter name T3220 indicates the name of the target filter. The name may be, for example, the name of the filter designated by the model developer 1020 in the filter information G4065 of the model registration screen G4000, and may be used for displaying a filter type designation drop-down box G3025, a filter condition table G3040, and the like of the evaluation setting screen G3000.

The description T3330 indicates a description of the filter information of the target filter. The description may be used for displaying a filter type description display area G3030 or the like on the model registration screen G4000.

The dataset identifier T3340 indicates the identifier of a dataset (a dataset associated with the target filter) to be processed by applying the target filter. The identifier may be, for example, the value of the dataset identifier T3010 included in the dataset management table T3100.

The selectable value T3340 indicates options for what conditions (conditions regarding extraction of dataset elements) can be designated for the dataset associated with the target filter. By displaying the options on the model evaluation screen G3000 or the like, a user can select a processing method that can be performed by the evaluation control program P6000, such as, for the filter with the file identifier extracting data of only bearing breakage or extracting data of only coil breakage with respect to a dataset with the dataset identifier “1” having the data of bearing breakage, coil breakage, and normal state of the motor.

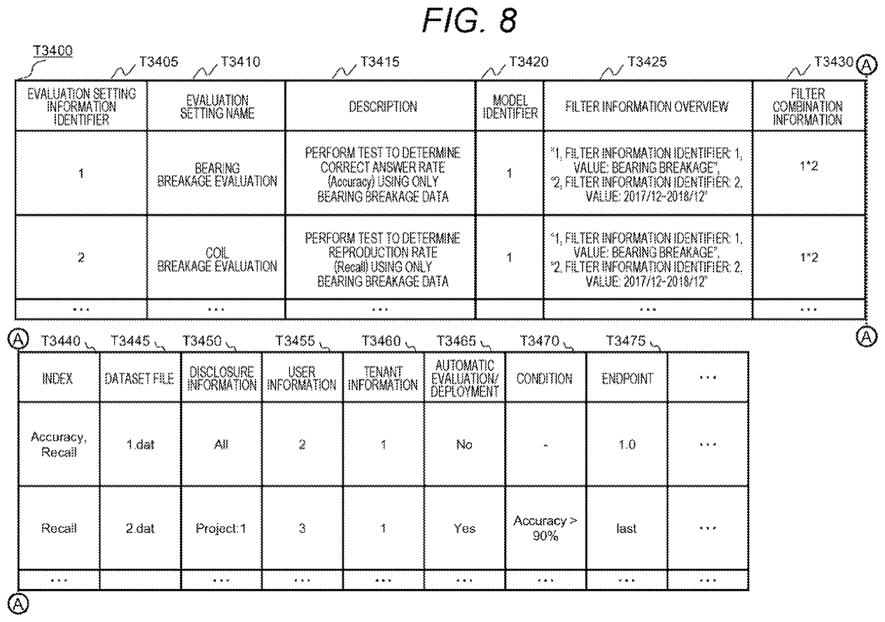

FIG. 8 is a diagram illustrating a configuration example of the evaluation setting management table T3400.

Each record in the evaluation setting management table T3400 stores evaluation setting information (information indicating what kind of processing and what kind of evaluation is performed using which dataset for which model when evaluating each model registered in the marketplace system 2000).

In the evaluation setting management table T3400, a record is stored for each evaluation setting. Hereinafter, one evaluation setting will be taken as an example (“target evaluation setting” in the description of FIG. 8).

The evaluation setting information stored in the record corresponding to the target evaluation setting includes an evaluation setting information identifier T3405, an evaluation setting name T3410, a description T3415, a model identifier T3420, a filter information overview T3425, filter combination information T3430, an index T3440, a dataset file T3445, disclosure information T3550, user information T3455, tenant information T3460, automatic evaluation/deployment T3465, a condition T3470, and an endpoint T3475.

The evaluation setting information identifier T3405 indicates an identifier for uniquely identifying the evaluation setting information of the target evaluation setting. The identifier may be a value (for example, a serial number) assigned by the data management program P3000.

The evaluation setting name T3410 indicates the name of the target evaluation setting. The name may be a name designated by the model developer 1020 in a setting name input textbox G3005 of the evaluation setting screen G3000, and may be used for displaying the evaluation result G2030 included in the model detail screen G2000.

The description T3330 indicates a description of the target evaluation setting. The description may be a description input by the model developer 1020 in a description input textbox G3010 of the evaluation setting screen G3000, and may be used for displaying the evaluation result G2030 included in the model detail screen G2000.

The model identifier T3420 indicates the identifier of a model belonging to the target evaluation setting. The identifier may be, for example, the value of the model information identifier T3005 included in the model management table T3000.

The filter information overview T3425 illustrates an overview of filter information belonging to the target evaluation setting. For example, the filter information overview T3425 may indicate what kind of dataset is processed and what kind of filter condition is used to perform evaluation on the evaluation target model. The filter information overview T3425 may include information on filter conditions listed in the filter condition G3040 designated by the user who performs evaluation on the model evaluation setting screen G3000.

In the filter information overview T3425, the information on the filter condition may be recorded in, for example, one or more rows, each row may be described in the form of “#” filter information identifier “X” and value “Y”, in which # in each row indicates a row number, X indicates the value of the filter information identifier T3300 included in the filter management table T3310, and Y indicates the value selected by the user who performs evaluation on the model evaluation setting screen G3000 among values of the selectable value T3340 included in the filter management table T3300.

The filter combination information T3430 is information indicating how to combine the filter information described in each row of the filter information overview T3425 and process data. For example, when the filter combination information T3430 is “1*2” with respect to the record in which the evaluation setting information identifier T3405 is “1”, the evaluation control computer P6000 extracts only data to which a label of bearing breakage is assigned among the information included in the dataset. Furthermore, since the operator is “*”, the period of data to be used for evaluation is further limited by the option “2017/12-2018/12” described in the second row of the filter information T3430 with respect to the extracted data (that is, only data belonging to the period is extracted), and the extracted data is used for evaluation of the model.

When the operator is “+”, data to which a label of bearing breakage is assigned or data whose data acquisition time (for example, year and month) is “2017/12” to “2018/12” is extracted. These operators are merely examples, and other operators and symbols may be included, for example, “not” for excluding designated data or operation priority designation using parentheses.

The index T3440 is information for designating an index to be obtained as an evaluation result, and examples thereof include “Accuracy” indicating accuracy, “Precision” indicating a matching rate, “Recall” indicating a reproduction rate, and “F-measure” indicating a harmonic average of accuracy and reproduction rate. As the index T3440, one designated by an index designation checkbox G3055 included in the model evaluation screen G3000 may be recorded.

The dataset file T3445 indicates the file name of a file in which the content of a dataset extracted by the evaluation control program P6000 according to the content of the filter combination information T3430 is recorded. The file name may be any value that can uniquely identify the file in the data management system 3000.

The disclosure information T3450 indicates a value for controlling a range in which the evaluation setting information of the target evaluation setting is disclosed. The value may be a value of the disclosure information T3050.

The user information T3455 indicates the identifier of a user who has evaluated the model. The identifier may be, for example, the value of the user identifier T3810 included in the user management table T3800.

The tenant information T3460 indicates the identifier of a tenant to which the user who has evaluated the model belongs. The identifier may be, for example, the value of the tenant identifier T3910 included in the tenant management table T3900.

The automatic evaluation/deployment T3465, the condition T3470, and the endpoint T3475 will be described later.

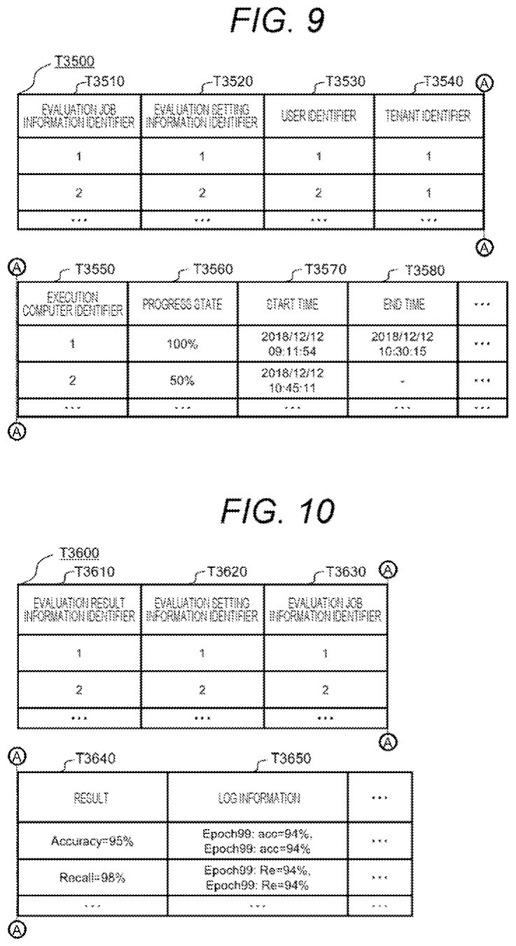

FIG. 9 is a diagram illustrating a configuration example of the evaluation job management table T3500.

Each record in the evaluation job management table T3500 stores evaluation job information (information indicating which evaluation execution computer P6100 executes the evaluation of each model, evaluation setting information of the evaluation, information for managing the progress state or the like of the evaluation).

In the evaluation job management table T3500, a record is stored for each evaluation job. Hereinafter, one evaluation job will be taken as an example (“target evaluation job” in the description of FIG. 9).

The evaluation job information stored in the record corresponding to the target evaluation job includes an evaluation job information identifier T3510, an evaluation setting information identifier T3520, a user identifier T3530, a tenant identifier T3540, an execution computer identifier T3550, a progress state T3560, a start time T3570, and an end time T3580.

The evaluation job information identifier T3510 indicates an identifier for uniquely identifying the evaluation job information of the evaluation job. The identifier may be a value (for example, a serial number) assigned by the data management program P3000.

The evaluation setting information identifier T3520 indicates an identifier for identifying evaluation setting information indicating on which model and with what setting the evaluation was executed for the target evaluation job. The identifier may be, for example, the value of the evaluation setting information identifier T3405 included in the evaluation setting management table T3400.

The user identifier T3530 indicates the identifier of a user who has evaluated the model. The identifier may be, for example, the value of the user identifier T3810 included in the user management table T3800.

The tenant identifier T3540 indicates the identifier of a tenant to which the user who has evaluated the model belongs. The identifier may be, for example, the value of the tenant identifier T3910 included in the tenant management table T3900.

The execution computer identifier T3550 indicates an identifier for identifying the evaluation execution computer 6200 that executes each evaluation. The identifier may be, for example, the value of one or more computer identifiers T3710 included in the computer management table T3700.

The progress state T3560 is a value indicating the progress state of each evaluation. The value may be expressed as a percentage, for example, “100%”, or may be expressed as a character string such as “dataset is being processed”, “evaluation is being executed”, or “completed”.

The start time T3570 and the end time T3580 indicate the start time and the end time of the target evaluation job. The start time may be, for example, the time when the evaluation control program P6000 receives a request for evaluation execution from the model management computer. The end time may be, for example, the time when the evaluation execution program P6100 detects completion of execution of the evaluation program file F3300.

FIG. 10 is a diagram illustrating a configuration example of the evaluation result management table T3600.

Each record in the evaluation result management table T3600 stores evaluation result information (information indicating the result of the model evaluation).

In the evaluation result management table T3600, a record is stored for each evaluation result. Hereinafter, one evaluation result will be taken as an example (“target evaluation result” in the description of FIG. 10).

The evaluation result information stored in the record corresponding to the target evaluation result includes an evaluation result information identifier T3610, an evaluation setting information identifier T3620, an evaluation job information identifier T3630, a result T3640, and log information T3650.

The evaluation result information identifier T3610 indicates an identifier for uniquely identifying the evaluation result information of the target evaluation result. The identifier may be a value (for example, a serial number) assigned by the data management program P3000.

The evaluation setting information identifier T3520 indicates an identifier for identifying evaluation setting information on which model and with what setting the evaluation for which the target evaluation result has been obtained has been executed. The identifier may be, for example, the value of the evaluation setting information identifier T3405 included in the evaluation setting management table T3400.

The evaluation job information identifier T3630 indicates an identifier for identifying information indicating which evaluation execution computer P6100 executes the evaluation for which the target evaluation result has been obtained. The identifier may be, for example, an evaluation job information identifier T3510 included in the evaluation job management table T3500.

The result T3640 includes information indicating a value obtained for the index as the target evaluation result. The information includes, for example, a result value with respect to the value of the index T3400, indicating on what kind of index the user wants to evaluate among the evaluation setting information stored in the evaluation setting management table T3440. For example, the result value may be collected and recorded from the log information output from the evaluation program file F3300 executed by the evaluation execution program P6100, or may be read and recorded from the standard output output from the evaluation program file F3300.

The log information T3650 is information in which a log related to the evaluation for which the target evaluation result has been obtained is recorded. The information may include, for example, the contents of logs, standard outputs, and standard errors output from the evaluation control program P6000, the evaluation execution program P6100, and the evaluation program file F3300.

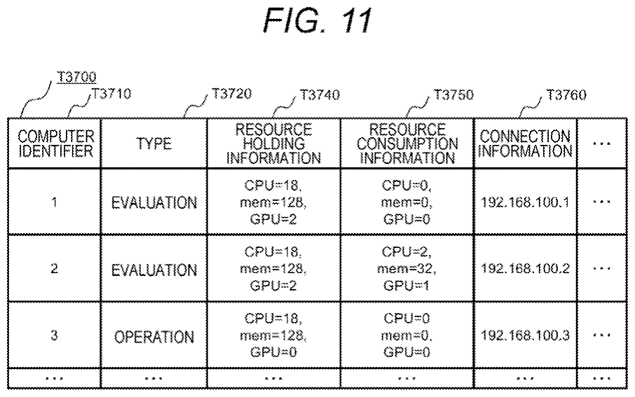

FIG. 11 is a diagram illustrating a configuration example of the computer management table T3700.

Each record in the computer management table T3700 stores computer information (information including resource holding information indicating performance of resources such as the CPU 1930, the memory 1920, and the GPU 1970 of the evaluation execution computer 6200 that executes evaluation of the model, resource consumption information, and information necessary for connection to the computer).

In the computer management table T3700, a record is stored for each computer. Hereinafter, one computer will be taken as an example (“target computer” in the description of FIG. 11).

The computer information stored in the record corresponding to the target computer includes a computer identifier T3710, a type T3720, resource holding information T3740, resource consumption information T3750, and connection information T3760.

The computer identifier T3710 indicates an identifier for uniquely identifying the target computer. The identifier may be a value (for example, a serial number) assigned by the data management program P3000.

The type T3720 is a value indicating the application of the target computer. For example, when the target computer is the evaluation execution computer 6200, the value is “evaluation”, for example.

The resource holding information T3740 is information indicating performance (for example, the performance of resources such as the CPU 1930, the memory 1920, and the GPU 1970) of a computation resource included in the target computer.

The resource consumption information T3750 indicates performance of a resource consumed by the target computer executing the evaluation execution program and the evaluation program file F3300 among the resource performance of the computation resource included in the target computer. The resource consumption information T3750 may be used for determining which evaluation execution computer P6100 executes evaluation of each model.

The connection information T3760 is information (for example, information necessary for connection to the target computer when the evaluation control program P6000 transmits a request for evaluation, such as an Internet Protocol (IP) address or a Uniform Resource Identifier (URI)) necessary for connection to the target computer.

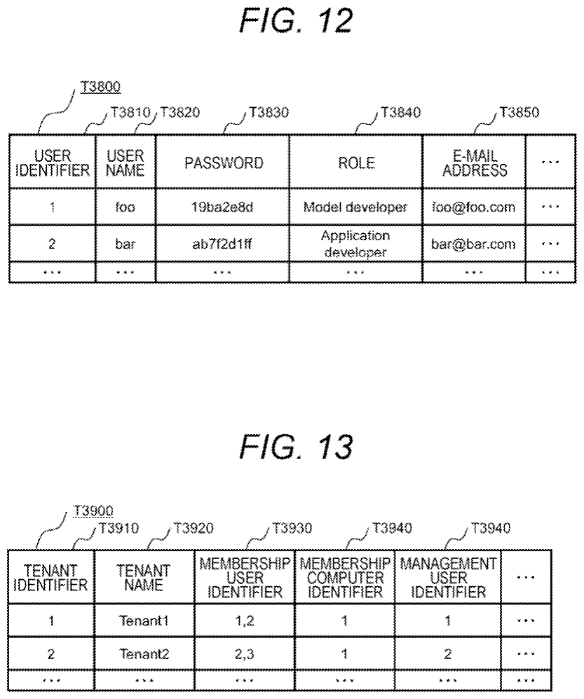

FIG. 12 is a diagram illustrating a configuration example of the user management table T3800.

Each record in the user management table T3800 stores user information (information of a user who uses the marketplace system 2000, such as the application developer 1000 and the model developer 1020).

In the user management table T3800, a record is stored for each user. Hereinafter, 1 user will be taken as an example (“target user” in the description of FIG. 12).

The user information stored in the record corresponding to the target user includes a user identifier T3810, a user name T3820, a password 3830, a role T3840, and an email address T3850.

The user identifier T3810 indicates an identifier for uniquely identifying the user information of the target user. The identifier is a value (for example, a serial number) assigned by the data management program P3000.

The user name T3820 and the password T3830 are a user name and a password (for example, information used as authentication information when the user accesses the marketplace system 2000 via a browser or the like included in the application development computer 1010 or the model development computer 1030) of the target user. The user name T3820 may be displayed in the model information G2010 or the like included in the model detail screen G2000, for example, as the name of the developer who has developed the model.

The role T3840 indicates the role of the target user. The value of the role T3840 may be, for example, “Model developer” in the case of the model developer 1020 who develops the model, or “Application developer” in the case of the application developer 1000 who develops the application.

The email address T3850 indicates an email address of the target user. The email address may be displayed in the model information G2010 or the like included in the model detail screen G2000, for example, as the name of the developer who has developed the model so that another user can contact the target user.

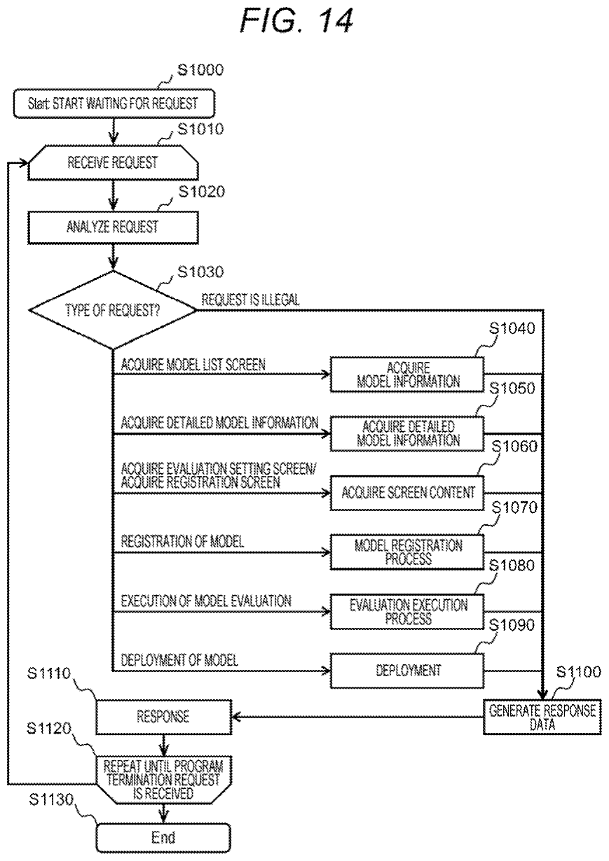

FIG. 13 is a diagram illustrating a configuration example of the tenant management table T3900.

Each record in the tenant management table T3900 stores tenant information (information on a tenant which is a group of one or more users or evaluation execution computers 6200 that use the marketplace system 2000, such as the application developer 1000 and the model developer 1020).

In the tenant management table T3900, a record is stored for each tenant. Hereinafter, one tenant will be taken as an example (“target tenant” in the description of FIG. 13).

The tenant information stored in the record corresponding to the target tenant includes a tenant identifier T3910, a tenant name T3920, a membership user identifier T3930, a membership computer identifier T3940, and a management user identifier T3940.

The tenant identifier T3910 indicates an identifier for uniquely identifying the tenant information of the target tenant. The identifier may be a value (for example, a serial number) assigned by the data management program P3000.

The tenant name T3910 is a value indicating the name of the target tenant, and may be, for example, a character string.

The membership user T3930 is information for identifying one or more users belonging to the target tenant, and may be, for example, the value of the user information identifier T3810 included in the user management table T3800.

The membership computer identifier T3940 is information for identifying one or more computers such as the evaluation execution computer 6200 belonging to the target tenant, and may be, for example, the value of the computer identifier T3710 included in the computer management table T3700.

The management user T3930 is information for identifying one or more users who manage the target tenant, and may be, for example, the value of the user information identifier T3810 included in the user management table T3800.

FIG. 14 is a flowchart of the IF program P2000.

When the IF program P2000 is executed, the IF program P2000 starts waiting for a request in step S1000. The request includes, for example, information such as a type of the request, such as acquisition of a list of models managed by the marketplace system 2000 and execution of model evaluation, an identifier for uniquely identifying the model, and an identifier of a user who has made the request.

In step S1010, when the request is received, the processing proceeds to step S1020.

In step S1020, the IF program P2000 analyzes the information (for example, the type of the request, such as acquisition of model information or execution of evaluation, or the identifier of the user who has made the request) included in the received request. In step S1020, the IF program P2000 may execute a process of checking whether the format and content of the included data such as the type of request and the model identifier are valid.

In step S1030, the IF program P2000 determines the analyzed type of the request. When the result of the checking performed in step S1020 indicates that the request is invalid, the IF program P2000 may generate a response indicating that the request is invalid in step S1100.

When the result of the determination in step S1030 is model list acquisition, the IF program P2000 acquires all information of all records of the model management table T3000 in order to collect information necessary for the model list screen G1000 in step S1040.

When the result of the determination in step S1030 is detailed model information acquisition, the IF program P2000 acquires information on a model identifier that uniquely identifies the model from the content of the request in order to collect information necessary for the model detail screen, and then acquires information of the model corresponding to the identifier from the model management table T3000 in step S1050.

If the result of the determination in step S1030 is acquisition of model evaluation screen or acquisition of model registration screen, the IF program P2000 acquires the content necessary for the model registration screen G3000 or acquires the content necessary for the model evaluation screen G4000 in step S1060. A method of acquiring the content to be displayed on each screen will be described later in the description of each screen.

If the result of the determination in step S1030 is model registration, the IF program P2000 acquires information necessary for model registration from the request analyzed in step S1020, and adds the information as a new record to the model management table T3000 in step S1070.

If the result of the determination in step S1030 is model evaluation execution, the IF program P2000 acquires evaluation condition information necessary for executing model evaluation from the request analyzed in step S1020, adds a new record to the evaluation condition management table T3400, and further transmits the identifier T3410 included in the added record to the evaluation control program P6000 included in the evaluation control computer 6100 in step S1080.

In step S1100, the IF program P2000 generates response data to be transmitted to a calling computer, such as the information on the model list screen and the model registration result, on the basis of the data collected in response to the request.

In step S1110, the IF program P2000 transmits the response data generated in step S1100 to the calling computer.

In step S1120, when there is no termination request for the IF program P2000 from the OS or the like, the processing returns to step S1010. When there is the termination request, the processing proceeds to step S1130, and the IF program P2000 ends.

The request determined in step S1020 may include acquisition and update of user information of the application developer 1000 and the model developer 1020, forced termination of the model evaluation processing being executed, and the like. Furthermore, the element displayed on the screen may be realized by an API having parameters corresponding to input/output items of each screen. The model deployment (step S1090) will be described later.

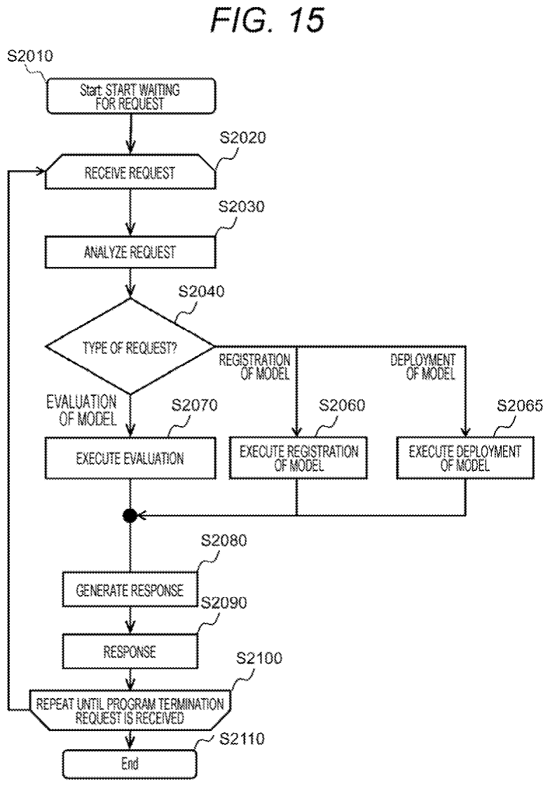

FIG. 15 is a flowchart of the model management program P2100.

When the model management program P2100 is executed, waiting for a request is started in step S2010. The request includes request information necessary for processing, such as a type of request such as model evaluation and model registration.

When the request is received in step S2020, the processing proceeds to step S2030.

In step S2030, the model management program P2100 analyzes information on the received request such as the type of request.

In step S2040, the model management program P2100 determines whether the type of the request included in the analyzed result is model evaluation, model registration, or model deployment. The processing proceeds to step S2070 if the request type is model evaluation, to step S2060 if the request type is model registration, and to step S2065 if the request type is model deployment. When the request type corresponds to neither the model evaluation nor the model registration, a response indicating that the request is incorrect may be generated in step S2080.

In step S2070, the model management program P2100 transmits the evaluation setting information to the evaluation control computer P6000 included in the evaluation system 6000 and requests the evaluation of the model in order to evaluate the model.

In step S2060, the model management program P2100 adds a new record to the model management table T3000 using the model information included in the request information analyzed in step S2030 in order to register the model included in the request information in the marketplace. At this time, it is confirmed whether there are records of models having the same name or the same model file, and when the records overlap, a response indicating the fact may be generated in step S2080.

In step S2065, the model management program P2100 sends a model deployment request to the model operation computer 5100 included in the model operation system in order to deploy the model.

In step S2080, the model management program P2100 generates a response message indicating whether the request for model evaluation or model registration has succeeded, whether the received request information is illegal, and whether the request has failed, or the like.

In step S2090, the model management program P2100 returns the generated response to the request source IF program P2000.

In step S2100, it is confirmed whether there is a termination request for the model management program P2100 from the OS or the like included in the model management computer 2200. If there is no termination request, the processing returns to step S2020. When there is a termination request, the processing proceeds to step S2110, and the model management program P2100 ends.

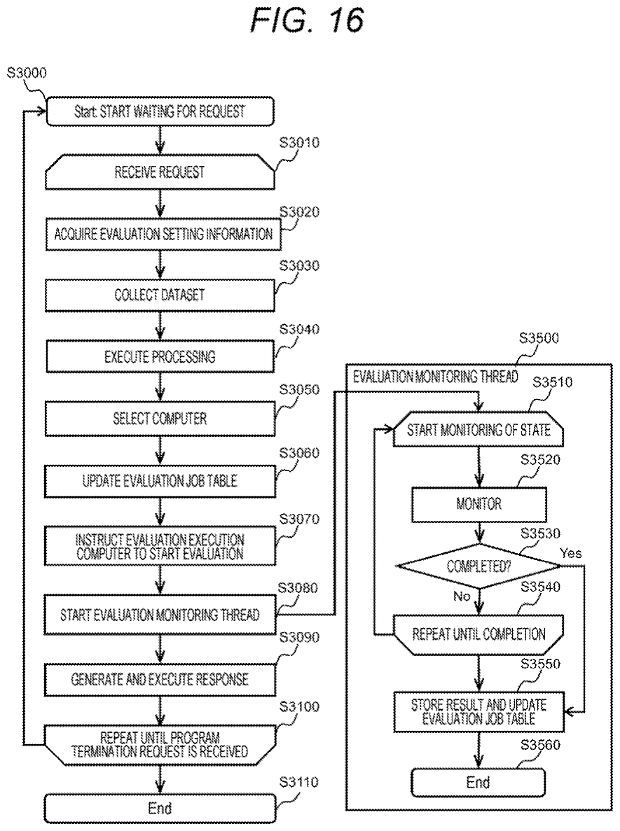

FIG. 16 is a flowchart of the evaluation control program P6000.

When the evaluation control program P6000 is executed, waiting for a request is started in step S3000. The request includes an evaluation target model, a dataset to be used, and evaluation setting information holding processing information of the dataset.

When the request is received in step S3010, the processing proceeds to step S3020.

In step S3020, the evaluation control program P6000 acquires the evaluation setting information identifier included in the request, identifies a record corresponding to the evaluation setting information identifier as a key from the evaluation setting management table T3400, and acquires the evaluation setting information.

In step S3030, the evaluation control program P6000 collects a dataset necessary for the evaluation of the model to be performed in the subsequent step. For example, first, the evaluation control program P6000 acquires the filter information overview T3425 from the acquired evaluation setting information, and identifies the corresponding record from the filter management table T3300 using the filter information identifier included in the filter information as a key. When a plurality of pieces of filter information is included in the record of the evaluation setting information, the evaluation control program P6000 acquires the corresponding filter information from the filter management table T3300 by the number of pieces of filter information. The evaluation control program P6000 acquires the dataset identifier T3340 from the acquired filter information. The evaluation control program P6000 acquires the file name T3180 included in the dataset management table T3100 using the acquired dataset identifier T3340 as a key, and collects the file of the dataset acquired from the data management computer 3100.

In step S3040, the evaluation control program P6000 creates evaluation data (processed data) by performing processing on the collected dataset according to the filter combination information (for example, processing of extracting the data of only bearing breakage from data including the failure states of various motors). A detailed example of step S3040 is, for example, as follows.

That is, in step S3040, first, the evaluation control program P6000 acquires filter information including information indicating what kind of processing is to be performed. The evaluation control program P6000 acquires, as filter information, a record corresponding to the filter information identifier T3425 from the filter management table T3300 using the value of the filter information overview T3300 as a key in the evaluation setting information acquired in step S3020. When a plurality of values are included in the filter information overview T3425, the evaluation control program P6000 repeats the processing the same number of times as the number of values to acquire a plurality of pieces of filter information. In addition, the evaluation control program P6000 acquires the value of the dataset identifier included in the acquired filter information.

Subsequently, the evaluation control program P6000 refers to the information in the filter combination information T3430 included in the evaluation setting management table T3400. The referenced filter combination information T3430 indicates how to process data by combining a plurality of filters. For example, when the filter combination information T3430 describes a condition of “1*2”, a case where the filter information having the acquired filter information identifier is “1: limitation of failure mode” and “2: designation of period”, and “*” is an AND condition is considered. First, the evaluation control program P6000 acquires the filter information in the filter management table T3300 using the filter information identifier included in the first filter information as a key. Further, the evaluation control program P6000 searches for a record corresponding to the dataset identifier T3340 of the dataset management table T3100 using the dataset identifier T3110 included in the acquired filter information. The evaluation control program P6000 acquires a file name T3180 (test1.dat) from the searched record, and this is the processing target data.

Subsequently, the evaluation control program P6000 refers to a value included in the filter information T3430 of the evaluation setting management table T3400 for the processing target data. In this case, since the value is “bearing breakage”, the evaluation control program P6000 performs processing of extracting only the data (dataset element) to which a label of bearing breakage is assigned from the processing target data. Furthermore, since the filter combination information T3430 is “1*2” and the operator is “*”, the evaluation control program P6000 applies the same procedure to the extracted data with respect to the second filter information in the filter information T3430, and extracts only the data belonging to the period of “2017/12-2018/12”. That is, the evaluation control program P6000 extracts only the data to which a label of bearing breakage is assigned and which belongs to the period of 2017/12 to 2018/12 for the processing target data (tesl.dat) as the processed dataset used for model evaluation.

When the operator is “+”, data to which a label of bearing breakage is assigned or data of which the data acquisition time is from 2017/12 to 2018/12 is extracted. These operators are merely examples, and other operators and symbols may be included, for example, “not” for excluding designated data or operation priority designation using parentheses.

The processed dataset is stored in the data management computer 3100 via the data management program P3000. The name of the dataset to be stored may be randomly determined or may be determined by a serial number or the like, and the determined name is recorded in the dataset file T3445 of the evaluation setting management table T3400.

In step S3050, the evaluation control program P6000 selects the evaluation execution computer 6200 that executes the model evaluation program F3300 in consideration of the resource consumption state and the like. Specifically, for example, the evaluation control program P6000 may extract a computer of which the type T3720 is “evaluation” from the information on the computers included in the computer management table T3700, and may further select a computer having the smallest resource consumption indicated by the resource consumption state T3750. Alternatively, for example, the evaluation control program P6000 may acquire information on the evaluation target model from the model management table T3000, and select a computer that satisfies the specifications required by the evaluation target model and has free resources from the evaluation request specifications and the resource holding information T3740 and the resource consumption information T3750 included in the computer management table T3700.

In step S3060, the evaluation control program P6000 adds a new record to the evaluation job management table T3500 in order to record the evaluation state of the model. In the added record, the evaluation setting information identifier T3520 is the evaluation setting information identifier T3405, the user identifier T3530 is the identifier of the user who has requested the evaluation among the user identifiers T3810 included in the user management table T3800, the execution computer identifier T3550 is the identifier of the selected evaluation execution computer 6200, the start time T3570 is a value indicating the current time, the end time T3580 is, for example, “−”, and the progress state T3560 is “0%”. A unique value is assigned to and recorded in the evaluation job identifier T3510 by the data management program P3000.

In step S3070, the evaluation control program P6000 requests the selected evaluation execution computer 6200 to execute model evaluation. The request is transmitted to the evaluation execution program P6100 included in the evaluation execution computer 6200. The identification of the evaluation execution computer 6200 may be performed using, for example, an IP address described in the connection information T3760 included in the computer management table. The transmitted request includes the evaluation setting information identifier and the evaluation job identifier T3510.

In step S3080, the evaluation control program P6000 starts an evaluation monitoring thread 53500 in order to monitor the state of the evaluation executed by the evaluation execution computer P6100. Accordingly, step S3510 is executed. After that, the processing proceeds to step S3090. That is, the steps after step S3080 and the steps after step S3510 are executed in parallel in the evaluation control computer 6100 by the thread.

In step S3090, the evaluation control program P6000 transmits a response to the model management program P2100 that has requested evaluation of the model. The transmitted response may include an error message informing that the execution of evaluation has started or an abnormality has occurred in any of the steps.

In step S3100, it is confirmed whether there is a termination request for the evaluation control program P6000 from the OS or the like of the evaluation control computer 6100. When there is no termination request, the processing returns to step S3010. When there is a termination request, the processing proceeds to step S3110, and the evaluation control program P6000 ends.

In step S3510 included in the evaluation monitoring thread, monitoring of the state of the evaluation of the executed model is started, and the processing proceeds to step S3520.

In step S3520, the evaluation monitoring thread inquires the evaluation execution computer P6100 about the execution state of the job having the evaluation job identifier, and obtains a response. The value of the response from the evaluation execution computer P6100 may be, for example, a value representing the state by a character string or a number such as “executing” or “stopped”, or a number indicating the progress state such as “10%” or “20%”, and the evaluation monitoring thread records the value of the obtained response in the progress state T3550 of the evaluation job management table T3500. In addition, the evaluation monitoring thread also collects resource consumption states of the CPU 1930 and the memory 1920 included in the evaluation execution computer P6100, and updates the resource consumption state T3750 of the computer management table T3700.

In step S3030, the evaluation monitoring thread determines whether the value of the response is a value indicating the completion of the model evaluation. For example, if the value is “completed” or “100%”, the processing proceeds to step S3550. Otherwise, the processing proceeds to step S3540, and then returns to step S3510.

In step S3550, the evaluation monitoring thread records a value of “100%” or “completed” in the progress state T3550 of the evaluation job management table T3500. The processing proceeds to step S3360, and the evaluation monitoring thread ends.

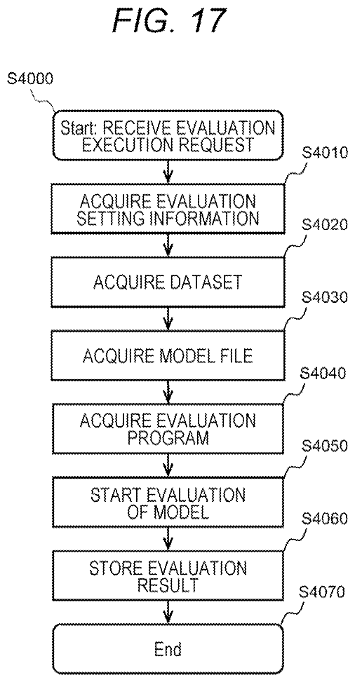

FIG. 17 is a flowchart of the evaluation execution program P6100.

When the evaluation control program P6100 is executed, a request from the evaluation control program P6000 is received in step S4000, and the processing proceeds to step S4010.

In step S4010, the evaluation execution program P6100 acquires the evaluation setting information from the evaluation setting management table T3400 using the evaluation setting information identifier included in the request as a key.

In step S4020, the evaluation execution program P6100 acquires the dataset file T3445 included in the acquired evaluation setting information via the data management program P3000.

In step S4030, the evaluation execution program P6100 acquires information on the evaluation target model from the model management table T3000 using the model identifier T3420 included in the acquired evaluation setting information as a key. Further, the evaluation execution program P6100 acquires the model file T3015 included in the acquired model information via the data management program P3000.

In step S4040, the evaluation execution program P6100 identifies the evaluation program file T3220 necessary for the evaluation of the target model from the evaluation program management table T3200 using the model identifier T3420 included in the acquired evaluation setting information as a key. Further, the evaluation execution program P6100 acquires the evaluation program described in the specified evaluation program file T3220 via the data management program P3000.

In step S4050, the evaluation execution program P6100 identifies index information from the index T3440. The evaluation execution program P6100 starts model evaluation by executing the evaluation program using the acquired dataset file, model file, and information on the specified index as inputs to the acquired evaluation program. After the evaluation program ends, the processing proceeds to step S4060.

In step S4060, the evaluation execution program P6100 acquires evaluation result information such as an index via, for example, a log file output by the evaluation program or a standard output, and adds the evaluation result information as a new record to the evaluation result management table T3600. In the added record, the evaluation setting information identifier T3620 may be an evaluation setting information identifier included in the request, the evaluation job information identifier T3630 may be an evaluation job information identifier included in the request, the result T3640 may be the acquired evaluation result information, and the log information T3650 may be, for example, a log file output by the evaluation program or a content of standard output.

In step S4070, the evaluation execution program P6100 ends.

Hereinafter, a screen (typically, a graphical user interface (GUI)) as an example of a user interface (UI) that can be displayed in the present embodiment will be described. For example, each screen is displayed on the application development computer 1010 or the model development computer 1030 by the IF program P2000 on the basis of the information acquired and provided by the data management program P3000.

FIG. 18 is a diagram illustrating an example of the model list screen G1000.

The model list screen G1000 is a screen illustrating a list of registered models. The screen G1000 can be displayed on both the application development computer 1010 and the model development computer 1030. For example, when the screen 1000G is displayed on the application development computer 1010, the application developer 1000 can select a model to be browsed from the list displayed on the screen 1000G. Furthermore, for example, when the screen 1000G is displayed on the model development computer 1030, the model developer 1020 can confirm a registered model or press the model registration button G1030 to register a new model.

The screen 1000G includes a plurality of UIs, for example, a model image G1010 of one or more models registered in the marketplace system 2000, a model name G1020, and a model registration button G1030 for registering a new model.

The information on each model displayed on the screen G1000 is acquired from the model management table T3000. For example, the image G1010 and the name G1020 are acquired and displayed from the image information T3060 and the model name T3005, respectively. The data management program P3000 refers to the value of the disclosure information T3030 included in the model management table T3000, and controls whether or not to disclose the screen G1000 to the access source user on the basis of the value. An example of the control is as follows, for example.
If the value is “All”, the screen G1000 is disclosed regardless of the access source user.
When the value is “user:1”, the screen G1000 is disclosed only when the identifier of the access source user is “1”.

The model registration button G1030 is a button (an example of a GUI component) for transitioning to the screen G4000 for registering a new model in the marketplace system 2000. The data management program P3000 may acquire information on the user from the user management table T3800 using the user identifier of the access source user as a key, and display the button G1030 only when the acquired role T3840 is “Model developer” indicating a model developer.

When a predetermined user operation such as clicking of the image G1010 of each model or the model name G1020 with a mouse pointer is performed, the screen may transition to the model detail screen G2000.

FIGS. 19A to 19C are diagrams illustrating an example of the model detail screen G2000.

The model detail screen G2000 illustrates detailed information on the model selected from the screen G1000. The screen G2000 includes a plurality of UIs, for example, a model name G2005, a model image G2007, model information G2010, a model version G2015, a model overview G2020, a model APIG 2025, a model evaluation result G2030 (FIG. 19B), a new model evaluation button G2035 (FIG. 19B), a new model version registration button G2040, deployed information G2050 (FIG. 19C), and a new deploy button G4055 (FIG. 19C).

The model name G2005, the model image G2007, the model overview G2020, and the model APIG 2025 are information acquired from the model name T3005, the image information T3060, the overview T3050, and the API specification T3055 included in the model management table T3000, respectively.

The displayed UI (item) may include, for example, the charging information included in the charging information T3040 included in the model management table T3000, and the like, in addition to the items illustrated in the drawing.

The model information G2010 is information acquired from the version information T3010 included in the model management table T3000 or information (information on the user who developed the target model and information acquired from the user name T3820) acquired from the user management table T3040 using the value of the user T3800 as a key.

The model version G2015 is a drop-down box for displaying the details of models of different versions, and is acquired from the version information T3010 of the model information in the record with the same value for the model group information T3070 in the model management table T3000 and is displayed.

The evaluation result information G2030 indicates the result of the evaluation performed on the target model, and is information acquired from the result T3640 included in the evaluation result management table T3600 or evaluation setting information acquired from the evaluation setting management table T3400 using the evaluation setting information identifier T3620 as a key.

The new model evaluation button G2035 is a button for receiving a request for newly evaluating the model from the application developer 1000 or the model developer 1020. When the button G2035 is pressed, the screen transitions to the model evaluation setting screen G3000.

The new model version registration button G2040 is a button for receiving a request for registering a new version of the model from the model developer 1020. When the button G2040 is pressed, the screen transitions to the model registration screen G4000.

The deployed information G2050 is a table that displays information in which each version of the model displayed on the screen is deployed. In the table, for example, each piece of information such as version information of the deployed model, an endpoint used for access using the API, and a deployment time, a button for deleting the deployed model and the endpoint, and the like are displayed.

The new deploy button G4055 is a button for receiving a request to newly deploy the version of the model displayed on the screen.

The deployed information G2050 and the new deploy button G4055 will be described later.

FIGS. 20A to 20C are diagrams illustrating an example of the model evaluation setting screen G3000.

The model evaluation setting screen G3000 is a screen for receiving the designation of an evaluation target model, a dataset to be used, a filter to be used, an evaluation index, and a disclosure range of an evaluation result. The screen G3000 includes a plurality of UIs, for example, an evaluation name textbox G3005, a target version input textbox G3007, a description textbox G3010, a dataset selection drop-down box G3020 (FIG. 20B), a filter type specification drop-down box G3025 (FIG. 20B), a filter type description display area G3030 (FIG. 20B), a condition value input drop-down box G3035 (FIG. 20B), a filter condition table G3040 (FIG. 20C), a filter condition addition button G3045 (FIG. 20B), a filter combination condition specification textbox G3050 (FIG. 20C), an index specification checkbox G3055, a disclosure specification textbox G3060, an evaluation execution button G3065, an automatic evaluation/deployment checkbox G3070, a condition input textbox G3075, and an endpoint input textbox G3080.

The displayed UI (item) may include, for example, the charging information T3040 included in the model management table T3000, the charging information T3150 included in the dataset management table T3100, the charging information included in the charging information T3250 included in the evaluation program management table T3200, and the like, in addition to the items illustrated in the drawing.

The evaluation name textbox G3005 is a textbox for inputting the name of evaluation. The value input to the box G3005 is recorded in the evaluation setting management table T3400 as an evaluation setting name T305.

The target version input textbox G3007 is a textbox for receiving the input of the version of the evaluation target model, a selectable drop-down box, or the like. The box G3007 may receive an input of a value that can specify the version of the model, such as the version number of the model, or may receive “latest” or the like indicating the latest version of the model.

The description textbox G3010 is a textbox for receiving the input of an evaluation description (for example, text in a text format or a Markdown format). The description input to the box G3010 is recorded in the evaluation setting management table T3400 as the description T3410.

The dataset selection drop-down box G3020 is a drop-down box for receiving selection of a dataset to which a filter is applied. The data management program P3000 searches the dataset management table T3000 using the dataset identifier T3075 included in the model management table T3100 as a key, and displays the file name T3180 of the record group matching the test data identifier T3110 as an option of the dataset selection drop-down box G3020.

The filter type designation drop-down box G3025 is a drop-down box for receiving selection of a type of filter to be applied to the dataset. The condition value input drop-down box G3035 is a drop-down box that displays options corresponding to the type of filter selected in the filter type designation drop-down box G3025 and receives designation of a filtering condition. The options in the filter type designation drop-down box G3025 follow the filter name of the record specified from the filter management table T3000 using the dataset identifier T3075 included in the model management table T3300 as a key. The options in the condition value input drop-down box G3035 follow the selectable value T3340 of the specified record.

When an option of the filter type designation drop-down box G3025 is selected, the description T3330 included in the filter management table T3300 may be displayed in the filter type description display area G3030.

The filter condition addition button G3045 is a button for receiving a request to add a filter selected via the dataset selection drop-down box G3020, the filter type designation drop-down box G3025, and the condition value input drop-down box G3035 to the filter condition table G3040. When the button G3045 is pressed, information on the selected filter is added to the filter condition table G3040.

The filter combination condition designation textbox G3050 is a box for receiving the designation of how to combine the filters displayed in the filter condition table G3040 to generate the dataset for model evaluation.

The index designation checkbox G3055 is a checkbox for receiving the designation of an index to be obtained as an evaluation result. Examples of the checkbox G3055 include “Accuracy” indicating accuracy, “Precision” indicating a matching rate, “Recall” indicating a reproduction rate, and “F-measure” indicating a harmonic average of accuracy and reproduction rate.

The disclosure designation textbox G3060 is a textbox for receiving designation (that is, designation of a disclosure range) of to which user the evaluation setting information input on this screen G3000 and the result information obtained by performing the evaluation are to be disclosed. Examples of the value that can be input as the disclosure range include “All” indicating disclosure to all users, and a user name or a user identifier for limiting disclosure to a specific user.

The evaluation execution button G3065 is a button for receiving a request to start the evaluation of the model using the evaluation setting information described above.

The automatic evaluation/deployment checkbox G3070 is a checkbox for receiving the designation of whether model evaluation will be automatically performed using the evaluation setting information input on the screen, for example, when the model developer 1020 registers a latest model in the marketplace system 2000, or the model will be deployed to the model operation system 5000 when a result of the evaluation matches the condition input in the condition input textbox G3075.

The condition input textbox G3075 is a textbox for receiving the input of a condition for automatically performing the deployment of the model to the model operation system 5000 when the automatic evaluation/deployment checkbox G3070 is checked.

The endpoint input textbox G3080 is a textbox for receiving the input of information on the endpoint of the API for using the function of the deployed model when the automatic evaluation/deployment checkbox G3070 is checked and the result of the evaluation matches the condition input in the condition input textbox G3075.

The automatic evaluation/deployment checkbox G3070, the condition input textbox G3075, and the endpoint input textbox G3080 will be described later.

FIGS. 21A to 21C are diagrams illustrating an example of the model registration screen G400.

The model registration screen G4000 is a screen for receiving model registration. The screen G4000 includes a plurality of UIs, for example, a model name input textbox G4010, a version input textbox G4015, an image path input textbox G4020, an image reference button G4023, a model file G4027, an evaluation program G4028, an execution program G4029, a model summary input textbox G4030, an API specification input textbox G4035, a dataset file path input textbox G4040 (FIG. 21B), a dataset reference button G4045 (FIG. 21B), a dataset name input textbox G4050 (FIG. 21B), a dataset addition button G4055 (FIG. 21B), an uploaded dataset management table G4060 (FIG. 21B), a filter management table G4065 (FIG. 21C), a filter information addition button G4075 (FIG. 21C), a disclosure input textbox G4070, and a model registration button G4080.

The information items to be displayed may include, for example, an item for receiving the input of charging information to be recorded as the charging information T3040, in addition to the items illustrated in the drawing.

The model name input textbox G4010 is a textbox for receiving the input of the name of the model to be registered. The value input to the box G4010 is recorded in the model management table T3000 as the model name T3005.

The version input textbox G4015 is a textbox for receiving the input of the version of a model to be registered. The value input to the box G4015 is recorded in the model management table T3000 as the version information T3010.

The image path input textbox G4020 is a textbox for receiving the input of the path of a file in the model development computer for an image file to be displayed on the model list screen G1000 or the model detail screen G2000. The path may be manually input, or the path of a file designated in a file selection dialog provided by the OS when the image reference button G4023 is pressed may be input.

The image upload button G4025 is a button for receiving a request to transmit and store the image file present in the path designated by the image path input textbox G4020 to the data management system 3000. When the button G4025 is pressed, the image file is stored in the data management system 3000.

The model file G4027 is a textbox for receiving the designation of a model file that is an entity of a model. The designated model file is used when evaluating the model and operating the model.

The evaluation program G4028 is a textbox for receiving the designation of a program used when the model is evaluated by the evaluation system 6000.

The execution program G4029 is a textbox for receiving the designation of a program for operating the model file deployed in the model operation system 5000. The execution program G4029 will be described later.

The model overview input textbox G4030 is a textbox for receiving the input of an overview of a model to be registered (for example, text in a text format or a Markdown format). The value input to the box G4030 is recorded as the overview T3055 in the model management table T3000.

The API specification input textbox G4035 is a textbox for receiving the input of an API specification (for example, text in a text format, a Markdown format, a JSON format, a YAML format, or the like) for using a registered model. The value input to the box G4035 is recorded in the model management table T3000 as the API specification T3060.

The dataset file path input textbox G4040 is a textbox for receiving the input of the path of a file in the model development computer 1030 for a dataset used for evaluation of the model. The path may be manually input, or the path of a file designated in a file selection dialog provided by the OS may be input when the dataset reference button G4045 is pressed.

The dataset name input textbox G4050 is a textbox for receiving the input of the name of the dataset. The value input to the box G4050 is recorded in the dataset management table T3100 as the dataset name T3120.

The dataset addition button G4055 is a button for receiving a request for transmitting the file of the dataset present in the path designated in the dataset name input textbox G4050 to the data management system 3000 and storing the same. When the button G4055 is pressed, the dataset file F3200 is stored in the data management system 3000.

The uploaded dataset management table G4060 is a table that displays information on the stored dataset, and information on one dataset is displayed in each row. The corresponding dataset file F3200 may be deleted from the data management system 3000 when a delete button arranged in each row is pressed.

When the stored dataset is used for evaluation of the model, the filter management table G4065 is a table indicating information on a designatable filter, and one piece of filter information can be input to each row. When the filter information addition button G4075 is pressed, a new row may be added to the filter management table G4065.

The disclosure input textbox G4070 is a textbox for receiving the designation (that is, designation of a disclosure range) of to which user the information on the model to be registered is to be disclosed. An example of a value that can be input as the disclosure range is as described above (for example, “All” indicating disclosure to all users).

The model registration button G4080 is a button for receiving a request for transmitting the model file present in the path designated by the model file G4027 to the data management system 3000 and storing the same and transmitting a model registration request to the IF program P2000 using the model information input on the screen G4000, and receiving a request for executing registration of a new model in the marketplace system 2000.

According to the present embodiment, it is possible to support quick model acceptance determination and load reduction of the application developer 1000 in a state where the dataset is not disclosed to the application developer 1000.

Furthermore, as described above, in the present embodiment, it is possible to automatically deploy the model according to the deployment of the model developed by the model developer 1020 and the result of the model evaluation. As a result, in addition to supporting quick model acceptance determination and load reduction of the application developer 1000 in a state in which the dataset is not disclosed to the application developer 1000, a state in which each model is deployed to the model operation system 5000 and the model can be used from each application is realized. Furthermore, since evaluation is automatically executed and deployed when the model is updated, it is expected that the model called by the application is always kept up to date. This point will be described below.

For example, referring to FIGS. 2A and 2B, the following can be said as an example.
There are the operation management table T4100 including model operation information necessary for operation of the deployed model, the model execution program file F3400 that reads the model file F3000 and provides an API for using the function of the model, and the model operation system 5000.
The model operation system 5000 includes one or more model operation computers 5100 and one or more model execution computers 5200. The model operation computer 5100 includes a model operation program P5000 that manages the model being executed and a route control program P5050 that controls access to the model via the API. The model execution computer 5200 includes a model service P5100 that provides the functions of one or more developed models. The model operation computer 5100 and the model execution computer P5100 may include means for recording a log including the operation information of each model and a function for transmitting the log to another computer.
The route control program P5050 may be any program as long as it can control the access route to the deployed model via the API.

Furthermore, for example, referring to FIG. 4, the following can be said as an example.
The model operation program file information T3080 indicates the file name of the model execution program file F3400 necessary for operating the model. In the information T3080, for example, a name assigned by the data management program P3000 when a file designated by the user in the execution program G4029 included in the model registration screen G4000 is registered in the data management system 3000 may be recorded.

Furthermore, for example, referring to FIG. 8, the following can be said as an example.
For example, the automatic evaluation/deployment T3465 indicates a value that designates whether model evaluation will be automatically performed using the evaluation setting information input on the screen when the latest model is registered in the marketplace system 2000 by the model developer 1020, and whether the model will be deployed to the model operation system 5000 when the result of the evaluation matches the condition input in the condition input textbox G3075. The value may be a binary value such as “Yes” or “No”.
The condition G3075 indicates a condition when the value of the automatic evaluation/deployment T3465 is “Yes”, for example, and the model is automatically deployed to the model operation system 5000.
The endpoint T3475 indicates information on an endpoint of an API for utilizing the function of the deployed model when the value of the automatic evaluation/deployment T3465 is, for example, “Yes” and satisfies the condition described in the condition G3075.

Furthermore, for example, referring to FIG. 16, the following can be said as an example.
Step S3555 is added after step S3550. As a result, the model deployment is automatically performed according to the result of the model evaluation.
In step S3555, the evaluation control program P6000 refers to the automatic evaluation/deployment T3465 included in the evaluation setting management table T3400. For example, when “Yes” indicating that the automatic evaluation/deployment is valid is described, the evaluation control program P6000 refers to the condition information described in the condition T3470. The evaluation control program P6000 compares the condition information with the information on the evaluation result obtained in step S3550. When the conditions match, the evaluation control program P6000 transmits a model deployment request to the model operation program P5000 included in the model management system 500.
For the automatic execution of the model evaluation, for example, the model management computer 2200 may has a function of monitoring so that the process of periodically executing the evaluation is performed in step S2070 included in the model management program P2100 and evaluation is performed again when the target model is updated if the automatic evaluation/deployment checkbox G3070 included in the model evaluation setting screen G3000 is enabled and the automatic evaluation/deployment T3465 included in the evaluation setting management table T3400 is “Yes”.

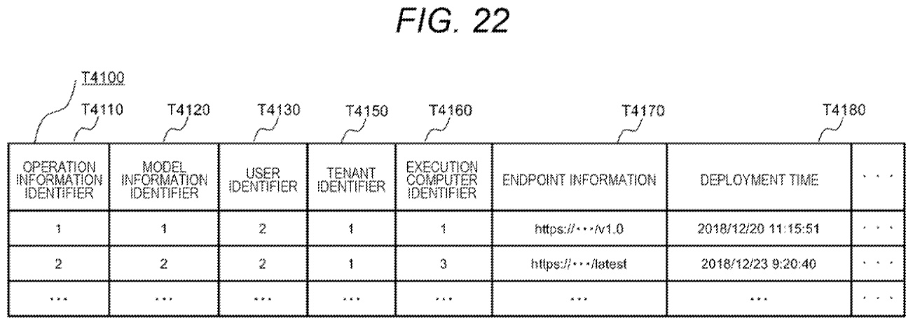

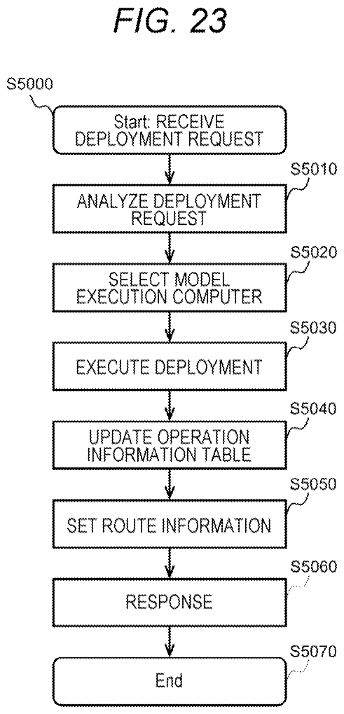

In addition to the above drawings, the description can be further made with reference to FIGS. 22 and 23.

FIG. 22 is a diagram illustrating a configuration example of the operation management table T4100.

Each record in the operation management table T4100 stores the operation information necessary for the operation of the deployed model.

In the operation management table T4100, a record is stored for each operation (model deployment). Hereinafter, one operation will be taken as an example (“target operation” in the description of FIG. 22).

The operation information stored in the record corresponding to the target operation includes, for example, a management information identifier T4110, a model information identifier T4120, a user identifier T4130, a tenant identifier T4150, an execution computer identifier T4160, end point information T4170, and a deployment time T4180.

The operation information identifier T4110 indicates an identifier for uniquely identifying the operation information of the target operation. The identifier may be a value (for example, a serial number) assigned by the data management program P3000.

The model information identifier T4120 indicates an identifier for identifying the model information including the information on the model deployed as the target operation. The identifier may be, for example, the value of the model information identifier T3005 included in the model management table T3000.

The user identifier T4130 indicates the identifier of a user corresponding to the target operation. The identifier may be, for example, the value of the user identifier T3810 included in the user management table T3800.

The tenant identifier T4150 indicates the identifier of a tenant to which the user corresponding to the target operation belongs. The identifier may be, for example, the value of the tenant identifier T3910 included in the tenant management table T3900.

The execution computer identifier T3550 indicates an identifier for identifying the model execution computer 5200 that executes the model execution program file corresponding to the model deployed as the target operation. The identifier may be, for example, the value of the computer identifier T3710 included in the computer management table T3700.

The endpoint information T4170 indicates the URI of the endpoint of the API for using the function of the model deployed as the target operation. The endpoint information T4170 may include information other than the URI in place of or in addition to the URI as long as the information is necessary for using the function of the model.

The deployment time T4180 indicates the time when the model is deployed as the target operation. The time information may be displayed on the model detail screen G2000 in order for the user to refer to the information on the deployed model.

FIG. 23 is a flowchart of the model operation program P5000.

When the model operation program P5000 is executed, a deployment request is received in step S5000, and the processing proceeds to step S5010.

In step S5020, the model operation program P5000 analyzes the content of the request, and identifies the model information including the model identifier, the user information and the tenant information including the user information identifier and the tenant information identifier of the user who has made the request, and the endpoint information. The user information and the tenant information are identified from the user management table T3800 and the tenant management table T3900 using the user information identifier and the tenant information identifier, respectively. The model information is acquired from the model management table T3000 using the model information identifier. The model file T3020, the model execution program T3080, and the operation request specifications T3030 are identified from the model information. Further, the endpoint information is information generated using the user information identifier included in the obtained user information and model information, the model information identifier, and the version information of the model, for example, “https://abcd.com/deployed_model/user_information_identifier/model_information_identifier/version_information”.

In step S5020, the model operation program P5000 selects the model execution computer 5200 that executes the model execution program F3400 in consideration of the resource consumption state and the like. In step S5020, for example, the model operation program P5000 may extract information in which the type T3720 is “operation” from among the information on the computers included in the computer management table T3700, and may further select information having the smallest resource consumption state T3750. Alternatively, for example, the model operation program P5000 may select a computer that satisfies the specifications required by the deployment target model and has free resources from the operation request specifications T3030 included in the specified model information, the resource holding information T3740 included in the computer management table T3700, and the resource consumption information T3750.

In step S5030, the model operation program P5000 transmits a deployment execution request including the identified model file T3020 and information on the model execution program T3080 to the selected model execution computer 5200. The model execution computer 5200 that has received the deployment execution request collects the model file F3000 and the model execution file F3400 from the data management system 3000, and executes the model execution file F3400.

In step S5040, the model operation program P5000 adds a new record including the specified model information identifier, user information identifier, tenant identifier, endpoint information, and current time information to the operation management table T4100.

In step S5050, the model operation program P5000 transmits the information on the selected model execution computer 5200 and the information on the identified endpoint to the route control program P5050, and sets the route from the network viewpoint for access to the model so that the endpoint can be accessed from the application P4100 or the like present inside and outside the model operation system using the API.

In step S5060, the model operation program P5000 transmits an application including the fact that the deployment has succeeded and the fact that the deployment has failed due to some error to the model management program P2100 that has transmitted the deployment request. In step S5070, the model operation program P5000 ends.

As described above, in the present embodiment, in addition to supporting quick model acceptance determination and load reduction by the application developer 1000 in a state in which the dataset is not disclosed to the application developer 1000, a state in which each model is deployed to the model operation system and the model can be used from each application is realized. Furthermore, since evaluation is automatically executed and deployed when the model is updated, it is expected that the model called by the application is always kept up to date.

### Embodiment 2

A second embodiment will be described. In this embodiment, differences from the first embodiment will be mainly described, and description of common points with the first embodiment will be omitted or simplified.

In the second embodiment, the application developer 1000 can evaluate the model by combining the dataset independently prepared by the application developer 1000 in addition to the dataset registered by the model developer 1020 in the marketplace system 2000. As a result, the application developer 1000 can evaluate the model with a high degree of freedom in accordance with the requirements of the application P4100.

For example, referring to FIG. 15, the following can be said as an example.
Step S2045 is added between step S2040 and step S2070. As a result, the application developer 1000 can add a dataset.
In step S2045, the model management program P2100 acquires information input through the UI (the dataset file path input textbox G4040, the dataset reference button G4045, the dataset name input textbox G4050, the dataset addition button G4055, the uploaded dataset management table G4060, the filter management table G4065, the filter information addition button G4075, and the disclosure input textbox G4070) included in the model evaluation setting screen G2000 from the model evaluation request as information on the dataset designated by the application developer 1000. Further, the model management program P2100 adds a new record to the dataset management table T3100 on the basis of the acquired information, and adds the dataset file F3200 which is an entity of the dataset to the data management system 3000.

Furthermore, for example, referring to FIGS. 20A to 20C, the following can be said as an example.
The model evaluation setting screen G3000 includes a UI equivalent to the UI (the dataset file path input textbox G4040, the dataset reference button G4045, the dataset name input textbox G4050, the dataset addition button G4055, the uploaded dataset management table G4060, the filter management table G4065, the filter information addition button G4075, and the disclosure input textbox G4070) described with reference to FIGS. 21A to 21C. Further, when the evaluation execution button G3065 is pressed, the information input to the added item is transmitted to the model management program P2100 via the IF program P2000.

As described above, according to the second embodiment, the application developer 1000 can evaluate a model with a high degree of freedom in accordance with the requirements of the application P4100.

The description of some embodiments can be summarized as follows, for example.

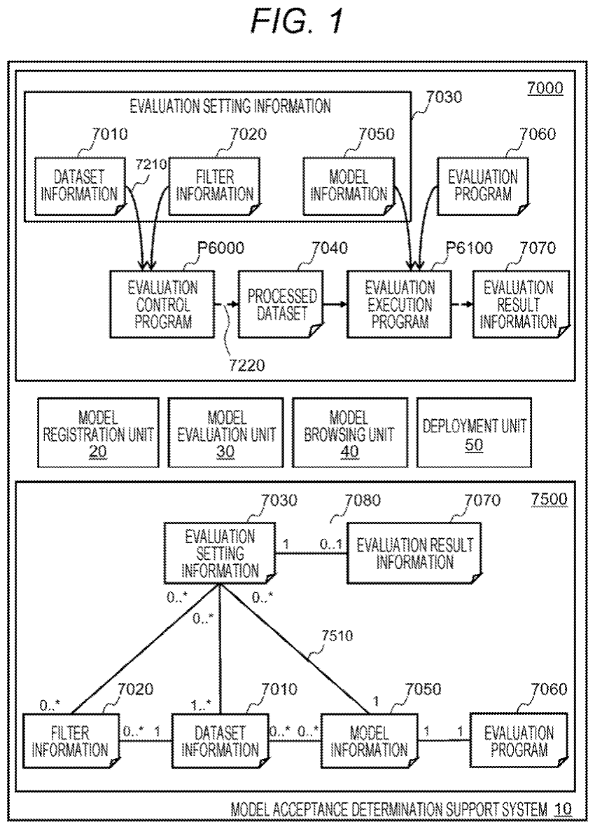

FIG. 1 is a diagram illustrating an example of an overview of a model acceptance determination support system.

The model acceptance determination support system 10 includes a model registration unit 20, a model evaluation unit 30, and a model browsing unit 40. The model acceptance determination support system 10 may include a deployment unit 50. At least one of the functions 20, 30, 40, and 50 is implemented by a processor executing at least one of the above-described programs (for example, the programs P2000, P2100, P3000, P5000, P5050, P5100, P6000, and P6100). In addition, the functions 20, 30, 40, and 50 may exist in one computer or may exist in a distributed manner in a plurality of computers.

The model registration unit 20 registers model information 7050 for each of one or more models, dataset information 7010 for each of one or more datasets, and filter information 7020 for each of one or more filters. Each of the one or more models is associated with a dataset which is one or more dataset elements that are input to the model among the one or more datasets. Each of the one or more datasets is associated with a filter of the dataset among the one or more filters.

The model evaluation unit 30 evaluates each of the one or more models using a processed dataset which is a dataset obtained on the basis of a dataset associated with the model and a filter associated with the dataset when the model is an evaluation target model.

The model browsing unit 40 displays at least a part of information associated with each of the one or more models and information indicating a result of evaluation of the model when the model is a browsing target model.

According to such a configuration, since the evaluation of the evaluation target model is performed by a computer different from the computer of the application developer 1000 (an example of the model user), the dataset (for example, the dataset prepared by the model developer) associated with the model is not disclosed to the model user. In addition, the processed dataset used in the evaluation is a dataset obtained using a filter of the dataset associated with the model, for example, a set of dataset elements that the application developer 1000 particularly wants to be input targets for evaluation. From the above, it is expected that the load on the application developer 1000 regarding the model acceptance determination is reduced even if it is difficult to disclose the dataset of the model developer 1020 to the application developer 1000.

Reference numeral 7000 in FIG. 1 schematically illustrates the flow of various types of information when the model registered in the model acceptance determination support system 10 (for example, a system including a marketplace system) is evaluated with a dataset and an index required by the application developer 1000. Solid arrow 7210 in the drawing indicates the input of information, and broken solid line 7220 indicates the output of information.

The evaluation setting information 7030 includes dataset information 7010, filter information 7020, and model information 7050 necessary for evaluation of the model, such as how to process the dataset and which model is to be evaluated.

The evaluation control program P6000 generates the processed dataset 7040 used for evaluation of the model using the dataset obtained from the dataset information 7010 and the filter obtained from the filter information 7020 as inputs.

The evaluation execution program P6010 evaluates the model using the model obtained from the model information 7050, the evaluation program 7060 associated with the model, and the above-described processed dataset 7040 as inputs, and outputs evaluation result information 7070.

The dataset input to the evaluation control program P6000 indicates a dataset necessary for evaluation of the model (a dataset associated with the model). However, the dataset may be used without being processed, or a processed dataset subjected to processing described later may be used. When the dataset is used without processing, the content of the processed dataset 7040 may be the same as the dataset obtained from the dataset information 7010.

The filter information 7020 includes information on how to process the dataset identified from the dataset information 7010. For example, when the dataset includes the data of bearing breakage, coil breakage, and normal state of a motor, processing of extracting data of only the bearing breakage may be performed to generate the processed dataset 7040.

The model information 7050 includes information for identifying an evaluation target model, and includes, for example, a model name, a version, a file path, and the like.

The evaluation result information 7070 includes information on the result of evaluating the model using the processed dataset 7040, and includes, for example, accuracy, a matching rate, a reproduction rate, specificity, an F-value indicating a harmonic average of the accuracy and the reproduction rate, and the like.

Reference numeral 7500 indicates a relationship among the dataset information 7010, the filter information 7020, the evaluation setting information 7030, the model information 7050, the evaluation program 7060, and the evaluation result information 7070 by solid line 7510 and multiplicity 7080.

Solid line 7510 indicates that the pieces of information connected to both sides have a relationship, and for example, the model information 7050 and the evaluation program 7060 have the multiplicity 7080 of “1”, indicating that one evaluation program 7060 is present for one piece of model information 7050. On the other hand, the dataset information 7010 and the filter information 7020 indicate that 0 or more pieces of filter information 7020 are present for one piece of dataset information 7010.

The evaluation setting information 7030 has 0 or more pieces of filter information 7020, one or more pieces of dataset information 7010, model information 7050, and 0 or more pieces of evaluation result information 7070. The dataset information 7010 has 0 or more pieces of filter information, and the model information 7050 is related to 0 or more pieces of dataset information 7010 and one evaluation program 7060. The dataset information 7010 is related to a plurality of pieces of model information 7050, and a plurality of models may share the same dataset and the filter information 7020 related to the dataset.

The filter information 7020 of each of the one or more filters may include a condition related to a dataset element input for evaluation of a model associated with the dataset among the datasets associated with the filter. For the evaluation target model, the processed dataset may be at least one dataset element (for example, at least one file) that meets the condition indicated by the filter information 7020 of the filter associated with the dataset among the datasets associated with the model. As a result, the processed dataset input to the evaluation target learning model can be narrowed down to dataset elements that meet the condition among the datasets associated with the learning model.

The model registration unit 20 may provide one or more registration interfaces to at least one model, the one or more registration interfaces being one or more UIs for receiving at least one of (r1) and (r2):

(r1) selection of one or more datasets associated with the model; and

(r2) selection of one or more filters associated with at least one dataset with respect to at least one dataset of the one or more datasets selected for the model. As a result, the model developer 1020 can limit the dataset associated with the model and the filter associated with the dataset.

The model evaluation unit 30 may provide one or more evaluation interfaces to an evaluation target model, the one or more evaluation interfaces being one or more UIs for receiving at least one of (e1) to (e4):

(e1) selection of one or more datasets associated with the model;

(e2) selection of one or more filters associated with at least one dataset;

(e3) a parameter as a condition for a dataset element of a dataset associated with at least one filter; and

(e4) selection of one or more evaluation indices. The model evaluation unit 30 may evaluate the evaluation target model according to the information received via the one or more evaluation interfaces. As a result, a user such as the application developer 1000 or the model developer 1020 can execute desired evaluation.

The model evaluation unit 30 may provide a UI for receiving selection of disclosure range information which is information indicating a disclosure range to which one or more users permitted as a browsing destination of information indicating the result of evaluation of the evaluation target model belong. The model browsing unit 40 may limit the information regarding the browsing target model to users belonging to the disclosure range indicated by the disclosure range information received regarding the model. In this manner, the disclosure range of the evaluation result of the model can be limited to some users, or the evaluation result of the model can be shared by a plurality of users.

The model evaluation unit 30 may select a computer (for example, a computer having the smallest resource consumption) from a plurality of computers on the basis of the resource consumption of the plurality of computers and cause the selected computer to execute evaluation of the evaluation target model. As a result, models can be evaluated efficiently.

The model evaluation unit 30 may calculate a charge amount required for evaluation of the evaluation target model in at least one of the following cases:
the model is associated with information on a charging amount for evaluating the model; and
the dataset used for evaluation of the model is associated with information on a charging amount for evaluation using the dataset. As a result, it is possible to calculate the value commensurate with allowing the application developer 1000 to execute desired model evaluation while evaluating models in a state where the dataset prepared by the model developer 1020 is not disclosed to the application developer 1000 (that is, allowing execution of model evaluation preferable for both the model developer 1020 and the application developer 1000).

The deployment unit 50 may automatically deploy the evaluation target model developed by the model developer 1020 to a location designated by the application developer 1000 when the result of the evaluation of the evaluation target model meets a predetermined condition (for example, the result obtained for an index designated by the application developer 1000 satisfies the condition designated by the application developer 1000). As a result, models can be operated efficiently.

In the evaluation of the evaluation target model developed by the model developer 1020, the model evaluation unit 30 uses not only the processed dataset based on the dataset selected by the model developer 1020 but also the dataset element belonging to the dataset input from the application developer 1000 who has requested the evaluation of the evaluation target model. As a result, it can be expected that the accuracy of model evaluation with an index desired by the application developer 1000 is improved.

### REFERENCE SIGNS LIST

10 model acceptance determination support system

1. A model acceptance determination support system comprising:
a model registration unit that registers model information on each of one or more learning models, dataset information on each of one or more datasets, and filter information on each of one or more filters,
each of the one or more learning models being associated with a dataset which is one or more dataset elements serving as an input of the learning model among the one or more datasets,
each of the one or more datasets being associated with a filter of the dataset among the one or more filters;
a model evaluation unit that evaluates each of the one or more learning models using a dataset associated with the learning model and a processed dataset which is a dataset obtained on the basis of a filter associated with the dataset when the learning model is an evaluation target learning model; and
a model browsing unit that displays at least a part of information associated with each of the one or more learning models and information indicating a result of evaluation of the learning model when the learning model is a browsing target learning model.

2. The model acceptance determination support system according to claim 1, wherein
the filter information of each of the one or more filters includes a condition regarding a dataset element that is input for evaluation of a learning model associated with the dataset among datasets associated with the filter, and
for the evaluation target learning model, the processed dataset is at least one dataset element that meets a condition indicated by filter information of a filter associated with the dataset among datasets associated with the learning model.

3. The model acceptance determination support system according to claim 1, wherein
the model registration unit provides one or more registration interfaces to at least one learning model, the one or more registration interfaces being one or more user interfaces that receive at least one of (r1) and (r2):
(r1) selection of one or more datasets associated with the learning model; and
(r2) selection of one or more filters associated with at least one dataset of the one or more datasets selected for the learning model.

4. The model acceptance determination support system according to claim 1, wherein
the model evaluation unit provides one or more evaluation interfaces to the evaluation target learning model, the one or more evaluation interfaces being one or more user interfaces that receive at least one of (e1) to (e4):
(e1) selection of one or more datasets associated with the learning model;
(e2) selection of one or more filters associated with at least one dataset;
(e3) a parameter as a condition for a dataset element of a dataset associated with at least one filter; and
(e4) selection of one or more evaluation indices, and
the model evaluation unit evaluates the evaluation target learning model according to the information received via the one or more evaluation interfaces.

5. The model acceptance determination support system according to claim 1, wherein
the model evaluation unit provides a user interface for receiving selection of disclosure range information that is information indicating a disclosure range to which one or more users permitted as a browsing destination of information indicating a result of evaluation of the evaluation target learning model belong, and
the model browsing unit limits the information regarding the browsing target learning model to users belonging to a disclosure range indicated by disclosure range information received regarding the learning model.

6. The model acceptance determination support system according to claim 1, wherein the model evaluation unit selects a computer from a plurality of computers on the basis of a resource consumption of each of the plurality of computers, and causes the selected computer to execute evaluation of the evaluation target learning model.

7. The model acceptance determination support system according to claim 1, wherein
the model evaluation unit calculates a charge amount required for evaluation of the evaluation target learning model in at least one of the following cases:
the learning model is associated with information on a charging amount for evaluating the learning model; and
the dataset used for evaluation of the learning model is associated with information on a charging amount for evaluation using the dataset.

8. The model acceptance determination support system according to claim 1, further comprising:
a deployment unit that automatically deploys the evaluation target learning model developed by a model developer to a location designated by a model user when a result of evaluation of the evaluation target learning model meets a predetermined condition.

9. The model acceptance determination support system according to claim 1, wherein in evaluation of the evaluation target learning model developed by a model developer, the model evaluation unit uses a dataset element belonging to a dataset input from a model user who has requested evaluation of the evaluation target learning model in addition to the processed dataset based on the dataset selected by the model developer.

10. A model acceptance determination support method comprising:
registering model information on each of one or more learning models, dataset information on each of one or more datasets, and filter information on each of one or more filters,
each of the one or more learning models being associated with a dataset which is one or more dataset elements serving as an input of the learning model among the one or more datasets,
each of the one or more datasets being associated with a filter of the dataset among the one or more filters;
evaluating each of the one or more learning models using a dataset associated with the learning model and a processed dataset which is a dataset obtained on the basis of a filter associated with the dataset when the learning model is an evaluation target learning model; and
displaying at least a part of information associated with each of the one or more learning models and information indicating a result of evaluation of the learning model when the learning model is a browsing target learning model.
